(19) United States
(12) Patent Application Publication
(10) Pub. No.: US 2026/0308717 A1
(43) Pub. Date: Oct. 8, 2026

(54) PROCESS FOR USING MODIFIED DTPA-ASSOCIATED ORGANOSILICA MEDIA FOR PRODUCING INDIVIDUALLY SEPARATED HIGH PURITY RARE EARTH ELEMENTS

(71) Applicant: Wayne State University, Detroit, MI (US)

(72) Inventors: Timothy M. Dittrich, Canton, MI (US); Mohammed S.Y. Dardona, Garden City, MI (US); Matthew J. Allen, Plymouth, MI (US)

(21) Appl. No.: 19/483,283

(22) PCT Filed: May 10, 2024
(86) PCT No.: PCT/US2024/028745

§ 371 Date: Nov. 11, 2025

Related U.S. Application Data
(60) Provisional application No. 63/466,017, filed on May 12, 2023.

(51) Int. Cl. C22B 59/00; B01D 15/18; B01D 15/20; B01D 15/24; B01D 15/38; B01J 20/22; B01J 20/288; B01J 20/34; C22B 3/24

(52) U.S. Cl. CPC C22B 59/00; B01D 15/1871; B01D 15/203; B01D 15/24; B01D 15/3828; B01J 20/223; B01J 20/288; B01J 20/3425; B01J 20/3475; C22B 3/24

(57) ABSTRACT

A process for solid-liquid extraction of rare earth elements (REEs) is disclosed. The process includes passing a mixed REEs solution through a plurality of columns containing a modified ligand-associated media to generate solution fractions; analyzing the solution fractions for REEs content and concentration; combining fractions from the same column into baskets based on the REEs content and concentration; and mixing baskets from different columns to produce enriched baskets.

### CROSS-REFERENCE TO RELATED APPLICATIONS

This application claims priority to U.S. Provisional Patent App. No. 63/466,017 filed on May 12, 2023, the contents of which are hereby incorporated by reference in its entirety.

### GOVERNMENT LICENSE RIGHTS

This invention was made with government support under contract no. DE-FE31565 awarded by the Department of Energy. The government has certain rights in the invention.

### TECHNICAL FIELD

This disclosure relates generally to solid-liquid extraction of rare earth elements (REEs), and particularly to separating individual REEs from REE-mix solution with a modified diethylenetriaminepentaacetic acid (DTPA)-associated organosilica media using a sequential column extraction technique.

### BACKGROUND

There is a lack of a domestic source of rare earth elements (REEs), which have many critical uses, including but not limited to the rapidly expanding electric vehicle market, cell phones, industrial magnets, and laptops. Currently, solvent extraction is commonly employed to separate REEs where large amounts of organic ligands and solvents are required for separation, which results in hazardous waste with considerable greenhouse gasses emissions.

The U.S. Department of Energy has identified the ability to separate REEs as a national security priority. Although other processes for REE concentration and separation from waste products, such as coal fly ash and electronic waste, have been proposed, there still is no economically viable and environmentally friendly technique that competes with conventional liquid-liquid separations.

As such, there exists a need for economical and environmentally friendly extraction methods from other underdeveloped sources of REEs, including but not limited to coal and coal-by products (e.g., bottom ash, fly ash).

### SUMMARY

According to the present disclosure, there is provided a method for separating individual rare earth elements (REEs) from an REE-mix solution using a sequential column extraction technique. The method employs a system of columns designed to separate individual REEs from a solution (e.g., coal fly ash leachate or electronic waste leachate) containing a mix of REEs and Th into high purity groupings referred to as “baskets”. Fractions of solutions from columns are combined and passed through one or more subsequent columns to achieve the high purity basket enriched in one or multiple REEs. The fractions may be analytically analyzed for REE content and concentration for determining what fractions to combine for subsequent column separation. The method is designed to be a more environmentally friendly approach to REE separations than solvent extraction by eliminating organic solvent use during the extraction process and with the potential for scalability and flexibility.

According to a first aspect, an exemplary process for sequential column separation of REEs may include passing a solution containing a mix of REEs through a first column containing a modified ligand-associated media; collecting effluent fractions of the solution from the first column; combining a first subset of the effluent fractions together to form a first combined fraction solution; combining a second subset of the effluent fractions together to form a second combined fraction solution, wherein the second subset of the effluent fractions differs in included REEs from the first subset of the effluent fractions; passing the first combined fraction solution through a second column containing the modified ligand-associated media and collecting effluent fractions of the first combined fraction solution; and passing the second combined fraction solution through a third column containing the modified ligand-associated media and collecting effluent fractions of the second combined fraction solution.

The process may further include analyzing the effluent fractions of the first combined fraction solution and of the second combined fraction solution to determine an REE concentration of the effluent fractions; and separating the effluent fractions of the first combined fraction solution into first baskets and the effluent fractions of the second combined fraction solution into second baskets, wherein each basket comprises effluent fractions of a similar REE concentration.

The process may further include combining at least one basket from the first baskets with at least one basket from the second baskets to form an enriched basket.

The enriched basket includes one or more REEs where an additive percentage of the one or more REEs amounts to at least 50% of a total concentration.

Additionally or alternatively, the first subset of the effluent fractions are combined based on a concentration and content of included REEs of each fraction.

Additionally or alternatively, the process may include adjusting a pH of the first combined fraction solution before passing through the second column.

Additionally or alternatively, the process may include passing at least one acidic release solution through the first column and collecting extracted fraction solutions; combining a first subset of the extracted fraction solutions together and at least one second subset of the extracted fraction solutions together, wherein the first subset of the extracted fraction solutions differs in concentration of REEs from the second subset of the extracted fraction solutions; and passing the first subset of the extracted fraction solutions through a fourth column containing the modified ligand-associated media.

The at least one acidic release solution may have a pH of between 0.0 and 2.0.

Additionally, or alternatively, the process may include passing a plurality of acidic release solutions through at least one of the second column and the third column and collecting fractions of the plurality of acidic release solutions, wherein a first of the plurality of acidic release solutions has a pH of about 1.6, a second of the plurality of acidic release solutions has a pH of about 1.0, and a third of the plurality of acidic release solutions has a pH of about 0.0.

The plurality of acidic release solutions are passed sequentially in order of the first of the plurality of acidic release solutions, then the second of the plurality of acidic release solutions, then the third of the plurality of acidic release solutions.

Additionally or alternatively, the modified ligand-associated media is a modified DTPA-associated organosilica media.

Additionally or alternatively, the solution containing the mix of REEs is a fly ash leachate solution.

Additionally or alternatively, the first column is larger than the second column and the third column.

According to a second aspect, an exemplary process for solid-liquid extraction of REEs may include passing a mixed REE solution through a plurality of columns containing a modified ligand-associated media to generate solution fractions; analyzing the solution fractions for REE content and concentration; combining fractions from the same column into baskets based on the REE content and concentration; and mixing baskets from different columns to produce enriched baskets.

Pursuant to an implementation, the passing of the mixed REE solution through the plurality of columns may include: passing the mixed REE solution through a first column containing the modified ligand-associated media and collecting effluent fractions of the mixed REE solution from the first column; combining a first subset of the effluent fractions together to form a first combined fraction solution; and passing the first combined fraction solution through a second column containing the modified ligand-associated media and collecting effluent fractions of the first combined fraction solution.

The passing of the mixed REE solution through the plurality of columns may further include passing at least one acidic release solution through the first column and collecting fractions of the at least one acidic release solution, wherein at least one of the fractions of the at least one acidic release solution are combined and passed through a subsequent column containing the modified ligand-associated media for REE extraction.

The at least one acidic release solution may have a pH of 0.0 to 2.0.

Additionally or alternatively, at least some effluent fractions from the second column are analyzed and combined with a second subset of the effluent fractions from the first column to form an enriched basket.

Additionally or alternatively, the enriched baskets contain one or more REEs with an additive percentage of at least 50% of a total concentration.

Additionally or alternatively, the mixed REE solution is prepared from a coal fly ash leachate or an electronic waste leachate. Additionally, or alternatively, the modified ligand-associated media includes diethylenetriaminepentaacetic acid (DTPA) functionalized with hydrophobic groups with the DTPA being chemically associated with an organosilica platform.

It will be appreciated that the above-mentioned features may be used not only in the combination stated but in other combinations or by themselves without departing from the scope of the disclosure. Various other features and advantages will be made apparent from the following detailed description and drawings.

### BRIEF DESCRIPTION OF THE DRAWINGS

While the claims are not limited to a specific illustration, an appreciation of the various aspects is best gained through a discussion of various examples thereof. Although the drawings represent illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrates are described in detail by referring to the drawings as follows:

FIG. 1 shows a schematic process flow diagram of a process for producing individually separated high purity REEs according to teachings of the present disclosure;

FIG. 2 shows a schematic process flow diagram of a process for sequential column extraction of REEs according to FIG. 1;

FIGS. 3A and 3B show solution types used in the sequential columns separation process;

FIG. 4 shows a schematic diagram of solutions fractions from Column 1 during the loading cycle and release cycles:

FIG. 5 shows a schematic diagram of the fractions generated from Column 1 during the loading and release cycles and their association with the separation columns (Columns 2-6);

FIG. 6 is a flow chart of Column 2 process and the mixed solution used in Column 3;

FIG. 7 is a graphic illustration of the loading and release cycles (C/C₀) of Column 1. The left y-axis is for all REE without Sc and Th while the right Y-axis is only for Sc and Th after PV 375. The release cycle in the graph is 10 times its value in the graph:

FIG. 8 is a graphic illustration of the concentration (ppm) of individual REEs+Th in the three mixes from the loading cycle of Column 1, with the numbers between brackets being pore volumes;

FIG. 9A is a graphic illustration of the release cycle of Column 1 at pH 0.6;

FIG. 9B is a graphic illustration of the release cycle of Column 1 at pH 0.0;

FIG. 10A is a graphic illustration of the loading cycle of Column 3;

FIG. 10B is a graphic illustration of the release cycle of Column 3 at pH 1.6, 1.0, and 0.2;

FIG. 11A is a graphic illustration of the loading cycle of Column 4;

FIG. 11B is a graphic illustration of the release cycle of Column 4 at pH 1.8, 1.0, and 0.5;

FIG. 12A is a graphic illustration of the loading cycle of Column 5

FIG. 12B is a graphic illustration of the release cycle of Column 5;

FIG. 12C is a graphic illustration of the loading cycle of Column 6;

FIG. 12D is a graphic illustration of the release cycle of Column 6;

FIG. 13 shows baskets collected from the different columns and their associated pore volumes;

FIG. 14A is a graphic illustration of an example of fractions enrichment from the loading cycle of Column 1:

FIG. 14B is a graphic illustration of an example of fractions enrichment from the two-pH release cycle of Column 1;

FIG. 15 shows a process for mixing baskets from different columns to produce enriched baskets.

### DETAILED DESCRIPTION

The present disclosure relates to the potential to couple hydrothermal leaching of coal fly ash with the engineering of custom-ligand-associated media to provide an organic solvent-free method of extracting and recovering rare earth elements (REEs). The present disclosure describes a solid-liquid separation technique using sequential media filled columns which removes the need for organic solvent in the separation process and facilitates increasing the efficiency and selectivity of extractions. According to the disclosure, a solution of a mix of REEs and Thorium (Th) is passed through a relatively large first column and then resulting fractions from loading and release cycles are collected, combined, and passed through subsequent columns. The fractions may be combined based on concentration and included REEs. Solution fractions are analyzed for REEs content and concentration after being passed through the columns, and fractions from the same column are combined into baskets. The baskets from different columns are then mixed, based on REEs content and concentration, to produce enriched baskets containing a high percentage (high purity) of one or more REEs.

According to an example, the ligand-associated media is a modified diethylenetriaminepentaacetic acid (DTPA)-associated organosilica media, such as that described in commonly owned co-pending U.S. application Ser. No. 17/520,869 filed on Nov. 8, 2021, now issued as U.S. Pat. No. 11,959,154, the contents of which are hereby incorporated by reference in its entirety. The DTPA is synthetically modified (functionalized) to include hydrophobic branched or linear aliphatic groups/chains (e.g., alkyl groups such as two hydrophobic ethylhexyl groups). The hydrophobic chains of the modified DTPA are attached to a solid support such as hydrophobic organosilica to form a modified DTPA-associated media for use in extractions of REEs.

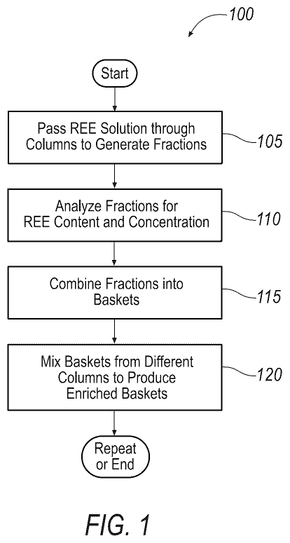

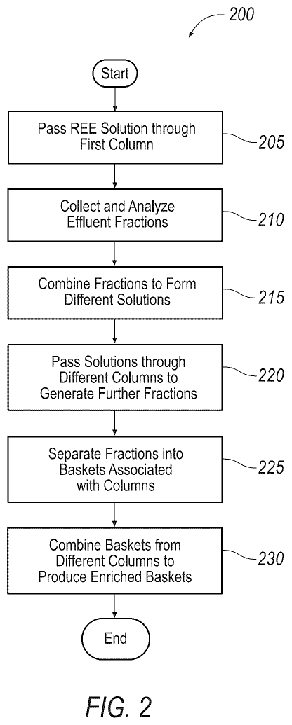

Referring now to the figures, FIG. 1 illustrates a schematic process diagram of an exemplary process 100 for producing individually separated high purity REEs. At step 105, a solution containing of mix of REEs and Th (e.g., a fly ash leachate solution) is passed through a series of columns packed with a ligand-associated media (e.g., a modified DTPA-associated organosilica media) to generate solution fractions. This stage of sequential column separation will be described in further detail with reference to FIG. 2 below. At step 110, the solution fractions are analyzed for REEs content and concentration. At step 115, the fractions of each column are separated into baskets with each basket comprising factions of similar REEs concentration. At step 120, baskets are mixed and combined from different columns to form enriched (high purity) baskets.

FIG. 2 illustrates a schematic process diagram of an exemplary process 200 for sequential column separation of REEs. At step 205, a solution containing of mix of REEs and Th (e.g., a fly ash leachate solution) is passed through a first column packed with a ligand-associated media (e.g., a modified DTPA-associated organosilica media) to generate solution fractions. At step 210, the fractions are collected and analyzed for REEs content and concentration. At step 215, the fractions are combined based on REEs content and concentration to form a plurality of fraction solutions. At step 220, the fraction solutions are passed through different columns to generate further factions associated with separate columns. At step 225, the further fractions are separated into baskets associated with the columns. At step 230, the baskets from different columns are analyzed and combined to produce enriched baskets. Each series of passing a solution through a column (e.g., steps 205 and 220) may include at least one loading cycle and at least one acid release cycle.

The exemplary experiments performed as part of the project in accordance with the process of FIGS. 1 and 2 will now be described in detail.

### Materials and Methods

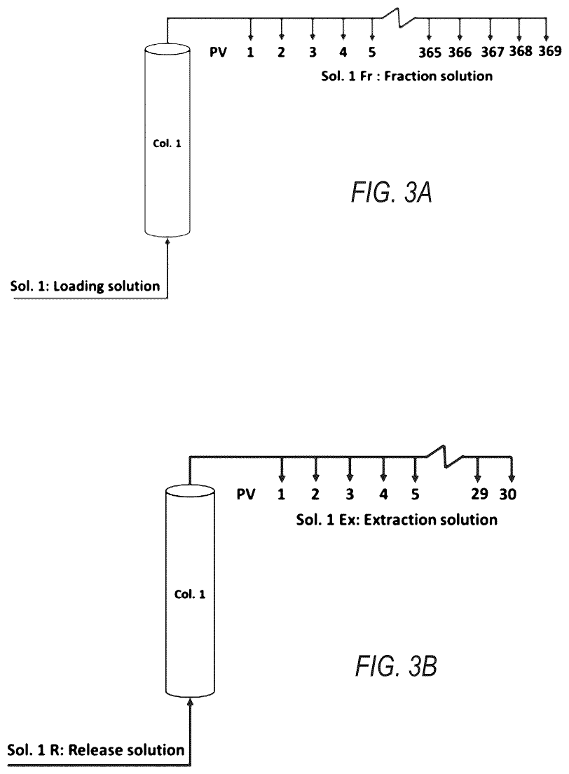

A simplified synthetic leachate solution and seven columns were prepared to test a sequential column concept for REEs and Th separation. Fractions of either column effluent or strip solution were collected using a fraction collector to enable analysis and mixing to produce influent solutions for a subsequent column. Each solution and column were given a unique name to differentiate the influent and effluent solutions from each step in the process. Each column run has four unique solutions associated with it: (1) the loading solution, (2) the collected effluent fractions, (3) the acid strip or release solution and (4) the extraction solution. The loading solution is the original solution containing mixed REEs and h and serves as the influent to the column. The effluent fraction solution is composed of a combination of effluent fractions, that are collected in a fraction collector over time. The release solution is an acidic solution (pH 1.6 to 0) that is prepared with ultra-pure nano water to strip REEs from the column. The extraction solution is the solution containing REEs extracted from the column after the release solution is passed through the column. Note that the collected effluent fractions and extraction solution from one column could be the loading solution of a subsequent column. A graphical explanation of this system is shown schematically in FIGS. 3A and 3B, where FIG. 3B shows the loading and fraction solutions during the loading cycle of Column 1, and FIG. 3B shows the release and extraction solutions of Column 1 during the release cycle.

### Synthetic Leachate Solution Preparation

A synthetic solution representing a simplified coal fly ash leachate was prepared and contained a mix of the 16 naturally abundant REEs plus Th (a radioactive element commonly found in fly ash leachate solutions). The synthetic solution was prepared with ICP-MS standards (High Purity Standards, ICP-MS B) to include 7 ppm of each REE (a total of 112 ppm REEs) plus 7 ppm Th. The solution pH was increased from 1.49 to 3.31 by adding 5 M sodium hydroxide made from weighing and dissolving pellets into a 3 L Erlenmeyer flask and diluting to an exact final mass (Fisher Chemical, MFCD00003548). This solution is referred to as Solution 1 (Solution 1) and was used as the starting solution to test the separation method. The release solution for column 1 (Solution 1R1) was prepared using nitric acid (Fisher chemical, ultra-trace. Optima) to produce a pH 0.60 (0.29 molar) solution and a volume of 500 mL. The second release solution 1R2 was prepared using the same acid but to reach a lower pH of 0.03.

### Sequential Columns Design

For the REE separation, six sequential columns were prepared. Borosilicate chromatography columns (Kontes, CHROMAFLEX, 12 mL, 1 cm diameter) were packed with varying amounts of modified DTPA media based on the volume of solution intended for injection. Some of the smaller columns later in the process were made using a micro-column design. Influent solutions were injected using either a peristaltic (Digital Miniflex, HV-07525-40) or syringe pump (Fisher scientific, 14-831-200) and column effluent was collected using a fraction collector (FC203B, Gilson) filled with glass test tubes (Fisherbrand, L 13 mm, Vol. 13 ml, 12-100-385).

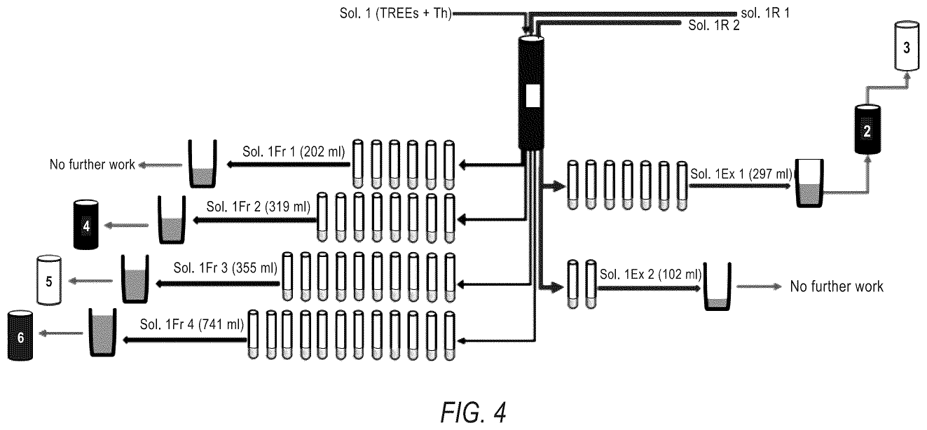

FIG. 4 shows a schematic representation of the series of sequential columns used for the loading and release cycles. For Column 1, the synthetic solution (Sol. 1) was first passed through the column, followed by two acid strip solutions (Sol. 1 R1 and Sol. 1 R2) of pH 0.6 and 0.03, respectively. After passing through Column 1, these solutions were collected in the fraction collector and analyzed for REEs and Th via ICP-MS. The data was then used to combine various fractions of the loading cycle (Sol. 1 Fr1, Sol. 1 Fr2, Sol. 1 Fr3, Sol. 1 Fr4) and the release cycle (Sol. 1 Ex1, Sol. 1 Ex2) for subsequent column injections (Columns 2-6). The size and solution chemistry of each column varied, with Column 1 being the first and largest column used in the separation process.

### Effluent Fraction Collection and Elemental Analysis

Based on the breakthrough data, the collected effluent fractions from Column 1 were collected in a fraction collector with each tube containing around 6 ml (1.39 PV). After ICP-MS analysis, these tubes were combined into four segments, Sol. 1 Fr1, Sol. 1 Fr2, Sol. 1 Fr3, Sol. 1 Fr4, as shown in FIG. 4. Sol. 1 Fr2, Sol. 1 Fr3 and Sol. 1 Fr4 had pH values of 2.68 that were adjusted to pH 3.25 using sodium hydroxide solution (5 M) prepared from NaOH pellets (Fisher Chemical, MFCD00003548) for subsequent injection into new columns.

Test tubes in the fraction collector were weighted before and after collection and the difference in measurement was calculated as the sample volume. An aliquot from the test tubes was pipetted and diluted for metal analysis purposes. Inductively coupled plasma mass spectrometry (ICP-MS) was used to analyze metal concentration in the collected test tubes. The calibration curve used for ICP-MS consisted of 11 samples (0, 0.005, 0.05, 0.5, 1, 5, 10, 50, 100, 150, 200) ppb. Indium was used as internal standard. Samples were diluted in 2% nitric acid and dilutions were made to ensure sample concentration was within the calibration curve range.

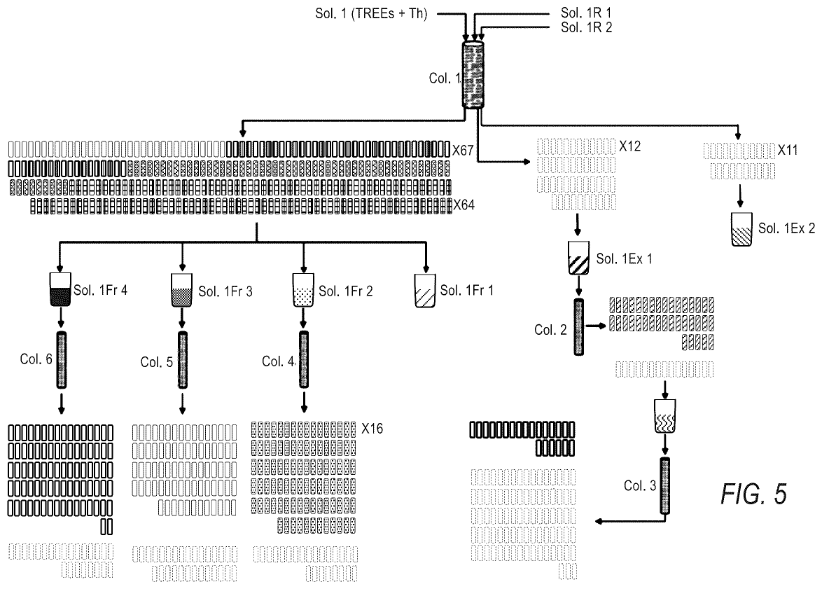

FIG. 5 illustrates schematically the fractions (loading/effluent and extracted/release) generated from Col. 1 and their association with the separation columns. The patterns of the effluent fractions (test tubes) from Col. 1 indicates the mixing of fractions. The black shaded tubes are all from the release cycles.

### Column 1

Column 1 was filled with 4.79 grams of the modified DTPA media and had a pore volume of 4.37 mL. Solution 1 (1617 mL) was pumped through the column at 12.09 mL/h flow rate, for a residence time of 22 minutes. Fractions were collected every 30 minutes (1.4 pore volumes—PV) with 6.05 ml in each tube.

A total of 369 pore volumes of influent solution were pumped through Column 1. The solutions collected in the test tubes in the fraction collectors during the loading process were then mixed for further separation. PV 1 to PV 46 were combined and called Sol. 1 Fr1, fractions from PV 47 to PV 119 were combined called Sol. 1 Fr2, PV 120 to 200 were combined and called Sol. 1 Fr3, and PV 201 to PV 369 were combined and called Sol. 1 Fr 4. The volumes of solutions and a flow chart of the collection process are shown in FIG. 4.

The release cycle of Column 1 was conducted in two steps. First, 68 PV of pH 0.6 nitric acid was passed through the column with a flow rate of 12.09 mL/hr. (Sol. 1 Ex1). Second, 23 PV nitric acid (pH 0.03) was pumped through Column 1 at flow rate of 4.4 mL/hr (Solution 1 Ex 2). This sums up to have a total of 91 PV during the release cycle. The results of the loading and release cycles conducted on Column 1 produced six solutions, Solution 1 Fr 1, Solution 1 Fr 2, Solution 1 Fr 3, Solution 1 Fr 4, Solution 1 Ex 1 and Solution 1 Ex 2. It is important to note that each of the six resulting solutions consist of mixing fraction collector fractions based on ICP-MS data from individual test tubes. FIG. 5 shows the distribution of fractions (test tubes) from Col. 1 to Col. 6, where tubes generated during the loading process of Col. 1 were mixed and passed through Col. 4, 5, and 6, while the first fractions of Col. 1 release were combined and passed through Col. 2 and followed by Col. 3.

Based on uniform concentration after one pass, Sol. 1 Fr1 (REE-free acid) and Sol. 1 Ex2 (>90% Th) were analyzed and put aside without any further column separation. Each fraction of Sol. 1 Ex1 was analyzed (~1.4 PV each, 0.6 mL in total). The first 2.86 PV were combined for further separation in Col. 2, while the rest of the fractions (65.14 PV) were combined and resulted in enriched Sc with no further processing. The first 2.86 PV of Sol. 1 Ex1 had a pH of 1.25 and a volume of 12.5 mL, and the pH of the solution was raised to 3.55. A spill during the mixing process led to a reduction in the solution volume from 12.5 to 7.6 mL. The 7.6 mL solution was passed through Col. 2. TABLE 1 shows the characteristics (sorbent mass, loading solution ID and volume, release solution ID and volume) of the sequential columns conducted.

TABLE 1

| Column 1D | Media (g) | Loading sol. (ID/ml) | Release sol. (Vol. mL/pH) | | |
|---|---|---|---|---|---|
| Column 1 | 4.79 | Solution 1/1617 | 297/0.6 | 102/0.0 | |
| Column 2 | 0.11 | Solution 1 Ex 1/7.6 | 2.4/0.4 | | |
| Column 3 | 1.94 | Sol. 2 Fr 1/9.8 | 8.8/1.56 | 6.5/0.98 | 11.2/0.21 |
| Column 4 | 1.79 | Solution 1 Fr 2/309 | 4.5/1.8 | 6.9/1.0 | 16.8/0.48 |
| Column 5 | 1.86 | Solution 1 Fr 3/355 | 14.2/1.49 | 11.5/1.0 | 16.9/9.9 |
| Column 6 | 3.83 | Solution 1 Fr 4/741 | 37.7/1.49 | 30.5/1.0 | 14.1/031 |

### Column 2

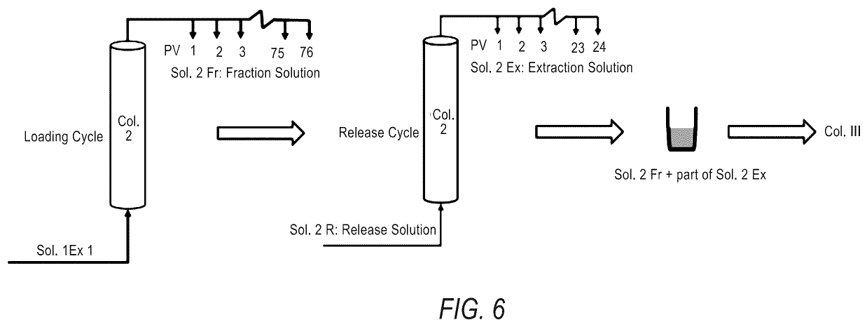

Col. 2 was designed to extract REEs and Th from the first 2.86 PV of the extraction solution of Col. 1 (Sol. 1 Ex1). Col. 2 had 0.11 grams media and a PV of 0.06 mL, the flow rate was 0.2 mL/h, a collection time of 1 tube/hour which leads to 18 minutes residence time and a total of 7.6 mL (76 PV) were passed. 24 PV (2.4 mL) of pH 0.4 nitric acid release solution was injected with a flow rate of 0.2 mL/h, collection time of 1 tube/hour. FIG. 6 shows the process conducted on Col. 2, and the mixed solution used in Col. 3. The loading fractions of Col. 2 (Sol. 2 Fr) were combined with the first 3.8 PV of the extraction solution (Sol. 2 Ex) and went through pH adjustment to reach a pH of 3.55 and was pumped through Col. 3. The rest of the release PV were combined and put aside.

### Column 3

Col. 3 was designed to extract REEs from Col. 2 solutions (Sol. 2 Fr+part of Sol. 2 Ex). Col. 3 had 1.94 grams media (1.10 mL PV), which means that 11.4 mL (7.6+3.8) solution accounts for 10.4 PV. The Col. 3 release cycle was conducted in three stages (see TABLE 1) with three different pH units and flow rates with a total of 24.7 PV (27.1 mL) of release solution injected through the column. First, 8.8 mL (8.0 PV) of pH 1.6 release solution was injected with a 0.5 mL/hr flow rate (132-minute residence time) and 1 tube/h collection time making a 0.5 PV in the collected fractions. Second, 7.1 mL (6.5 PV) of pH 0.98 solution was injected with a 2 mL/h flow rate (33-minute residence time) and 8 tubes/h collection time (0.23 PV in each test tube). Third, 11.2 mL (10.2 PV) of pH 0.2 solution was injected with a 1 mL/h flow rate (66-minute residence time) and 4 tubes/h collection time (0.27 PV in each test tube).

### Column 4

Col. 4 was intended to enrich light rare earth metals (LREEs) from the second combined fraction from Col. 1 (Sol. 1 Fr2). Sol. 1 Fr2 had a volume of 294 mL (FIG. 4) and the pH was adjusted from 2.68 to 3.27 by adding 80 μL of 5 M NaOH before being pumped through Col. 4. Col. 4 was filled with 1.79 grams of DTPA media and had a PV of 1.40. The flow rate was 3.2 m/h with a collection time of 1 tube/h=(26-minute residence time). The release cycle was conducted in three steps using three pH values (1.8, 1.0, and 0.48) and a flow rate of 1.6 mL/h for a total of 31 PVs.

### Column 5

Col. 5 was designed to enhance enrichment from Sol. 1 Fr3, which was enriched in both LREEs and heavy rare earth metals (HREEs) and depleted of Sc and Th. Col. 5 was packed with 1.86 grams media with a PV of 1.7 mL (see TABLE 1), a flow rate of 4 mL/h, collection time of 1 tube/h, and residence time of 25.5 minutes. The release cycle for Col. 5 was conducted in three steps using pH 1.49 (8.8 PV), pH 1.0 (7.2 PV), and pH 0.43 (9.0 PV) nitric acid. The flow rate for the release cycle was 1.6 mL/h for a total of 25.9 PV.

### Column 6

Col. 6 was designed to separate LREEs from HREEs, from Sol. 1 Fr4, which was enriched in both LREEs and HREEs and depleted of Sc and Th. Col. 6 had 3.84 grams of media with a PV of 3.5 mL. The flow rate was 8 mL/h, collection time 1 tube/h, and residence time was 26 minutes. The release solution was conducted in three steps using pH 1.49, 1.0, and 0.31 nitric acid with 10.9, 8.7, and 4.0 PV of solution, respectively. A total of 22.7 PV of release solution was pumped through the column.

### REE Basket Assembly Criteria—Basket Enrichment Percentage (BEP)

Baskets enriched in individual REEs and Th were prepared by combining different fractions from all the sequential columns based on the concentration and included REE elements of each fraction. The six conducted columns generated 810 test tubes collected in fraction collectors from the various loading and release cycles. Therefore, within each column, several baskets were made as a first step. These baskets comprise fractions with similar REE concentration. Once each column was divided into several baskets, mixing of baskets from different columns was done to get fewer and more enriched baskets.

A basket could be enriched in one or multiple elements, therefore a Basket Enrichment Percentage (BEP) concept was developed where the BEP is defined as the additive percentages of multiple REEs that equal or exceed 50% of the total concentration, for example, if a basket is named a “Dy, Ce and Eu Basket with a BEP value of 70%”, then adding the percentages of Dy, Ce and Eu together would account for 70% of total the total REE concentration, and neglecting the inclusion of one of the three elements would decrease the concentration to less than 50%.

### Results and Discussion

### Column 1

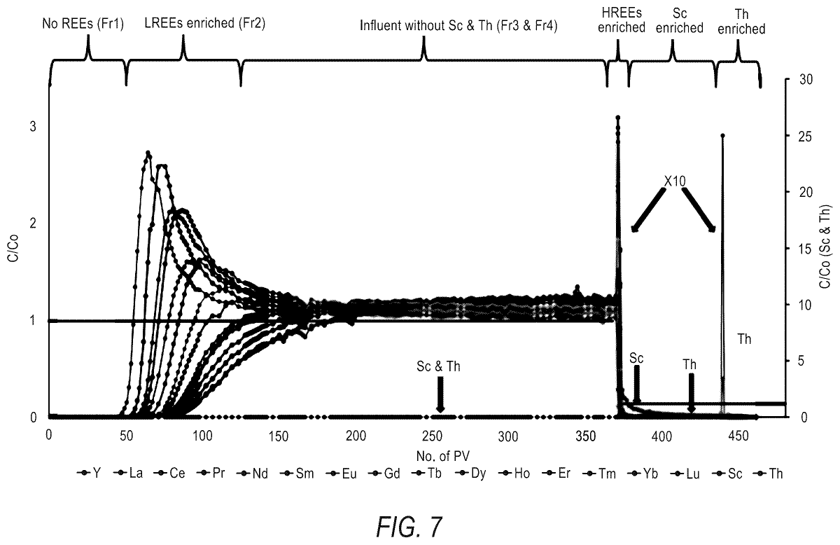

Col. 1 was loaded with 369 pore volumes (1.62 L) of equal amounts of REEs+Th, where each element accounts for 5.9% of the total concentration. FIG. 7 shows the loading and release cycles (C/C₀) of Col. 1, wherein left y-axis is for all REE without Sc and Th while the right Y-axis is only for Sc and Th after PV 375. The loading cycle of Col. 1 shows that all REEs+Th sorbed completely for the first 46 PV. Because the solution in the first 46 PV was free of REEs and Th, they were mixed (Sol. 1 Fr1) and set side without any further processing. Because this is an REE- and Th-free acid solution (pH 3.31), this solution could be recycled for future use. Samples from PV 47-119 were mixed (Sol. 1 Fr2) and enriched in LREEs where some LREEs (La, Ce, Pr, Nd) and Y have a value of C/C₀>1.

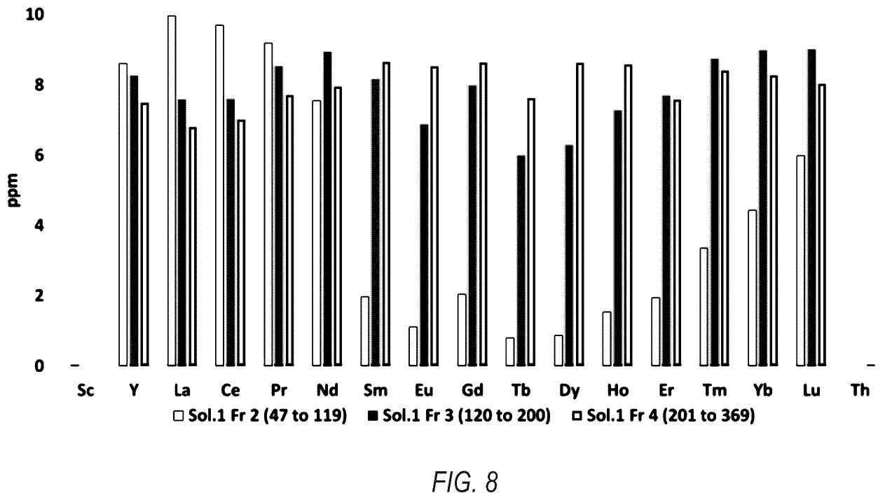

The concentration in ppm of REEs+Th of Sol. 1 Fr 1 are shown in FIG. 8. The percentages of Y, La, Ce, Pr and Nd in Sol. 1 Fr2 increased from 5.9% each to 12%, 14%, 14% 13%, and 11% respectively. The mix is also mildly enriched in Yb and Lu (7.6% for both) and most importantly the solution is Sc- and Th-free. Sol. 1 Fr2 was used as the influent solution for Col. 4.

The third segment of the loading cycle of Col. 1 starts from PV 120 until PV 200, where all the concentrations (except Sc and Th) are approaching C/C₀=1. These pore volumes are not very enriched, but the variability in concentration between individual REEs can be noticed, demonstrating separation (FIG. 8). For example, there is a difference of 2.6% between Lu and Th. and this solution is also Sc- and Th-free. Solutions from PV 201 to 369.4 are similar in elemental concentration to the influent solution minus Sc and Th. This evidence that modified DTPA media has a very high affinity for Sc and Th.

### Scandium and Thorium Separation

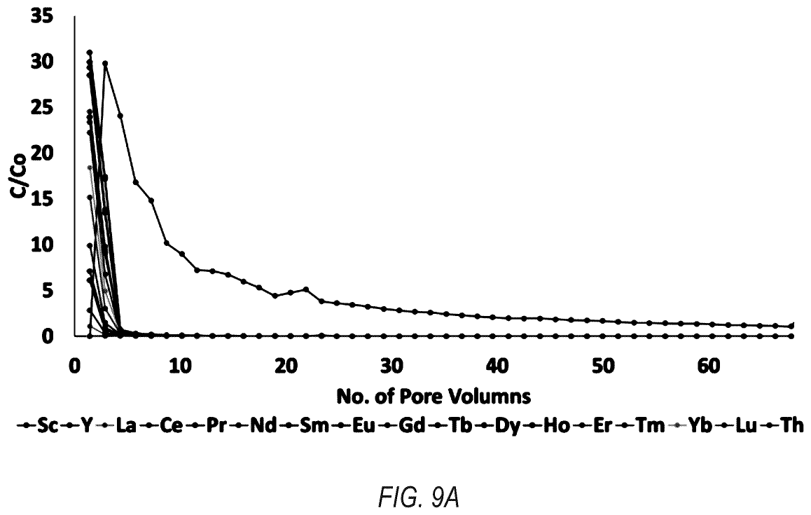

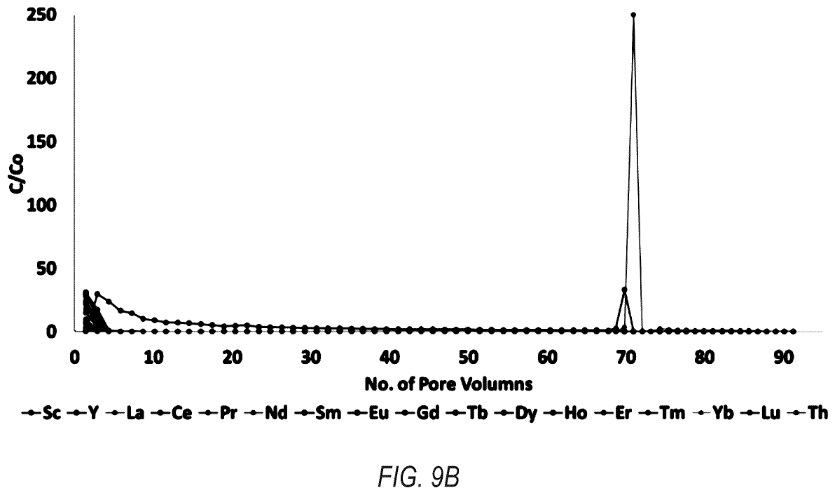

Scandium (Sc) and thorium (Th) were separated in high purity during the release cycle of Col. 1. The first stage of the release cycle was conducted at pH 0.6 and was combined to create two fractions. The first solution (Sol. 1 Ex1) combines samples from PV 1 to PV 2.7 of the release. This contained around 10 wt % of the total REE+Th mass that was injected through Col. 1 and was injected through Col. 2 for further removal/polishing of Sc and Th. The second part of the release at pH 0.6 is referred to as Basket 1. As shown in FIG. 9A after the first 2.86 PV, Sc started releasing gradually and steadily without any other elements in the solution until it reached PV 68.

The mass percentage of Sc in the collected fractions after PV 2.86 (Basket 1) is 92% and this accounts for more than 73% of the total Sc pumped through the column (1.6-liter, 7 ppm Sc). TABLE 2 shows the total mass of Sc, Th, and the TREEs (minus Sc and Th) pumped thought Col. 1 and their enrichment in the release cycle.

TABLE 2

| | Total pumped | First 2.68 PV | Basket 1 | Basket 2 |
|---|---|---|---|---|
| | (mg) | (mg) | (mg) | (mg) |
| Sc | 11.35 | 1.32 | 8.29 | 1.25 |
| Th | 11.14 | 0.00 | 0.04 | 9.03 |
| *TREEs | 169.2 | 16.56 | 0.68 | 0.01 |
| (minus Sc | | | | |
| and Th) | | | | |

Although >61% of the sorbed mass of the 16 REEs were released during the pH 0.6 release cycle, 99.7% of the Th remained in the column. The second stage of the release cycle (FIG. 9B) was conducted at pH 0.0 to target the Th that was not released at pH 0.6. The second release cycle released 81% of the Th mass injected through the column, in addition to 11% of the Sc mass injected through the column. Basket 2 is the thorium enriched basket that encompasses the solution from PV 69 to 91. The Th purity by mass in Basket 2 is 87% (with 11% being Sc, and <2% for the rest of REEs) and the yield of Basket 2 accounts for 81% of the Th pumped through Col. 1. There was still detectable Th in the release solution when the release cycle was stopped. To reach a higher purity, Basket 2 could be passed through an additional column where Sc and Th could be further separated.

It is important to point out that the enrichment of Sc and Th was done in one step, which is important not only from a Sc/Th separation perspective, but also eliminates these two metals from any competition with other REEs sorption in subsequent columns while increasing the effective capacity of the media in sorbing the other REEs.

### Sequential Column Studies

### Columns 2 and 3

Although the intent of Col. 2 was to further separate REEs from the concentrated strip solution from Column 1 (Column 1 Ex 1), the column was not appropriately designed. Column 2 had only 0.11 grams of media and the influent solution (first 2.86 PV from Col. 1 release) had a highly concentrated amount of REEs (2729.6 ppm), therefore, little sorption took place. That is the reason for combining all the fractions that resulted from the loading cycle of Col. 2 with the first 3.8 PV of the release cycle of the same column (Column 2) was completed and the fractions were put through Column 3. The rest of the solution (from PV 3.9 to 24) in the release cycle was combined as Basket 3. Basket 3 contained only 0.02% of the mass of TREEs injected through Col. 1, which means that the issue that took place with Column 2 was fixed with slight loss of REEs.

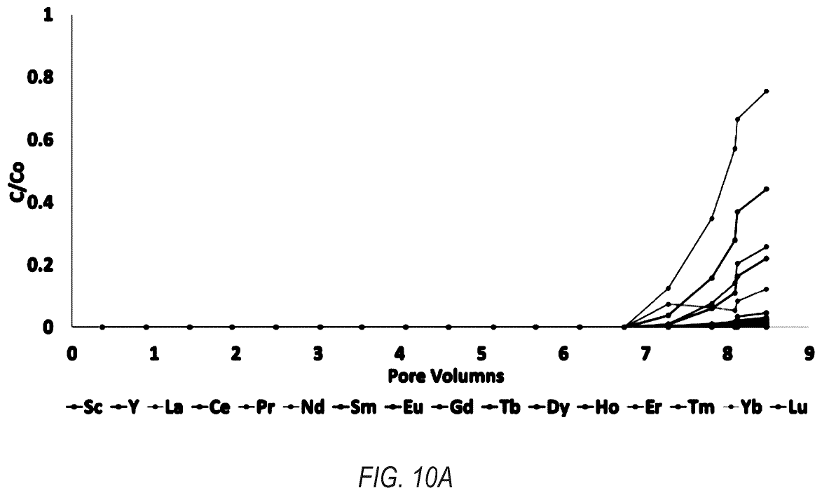

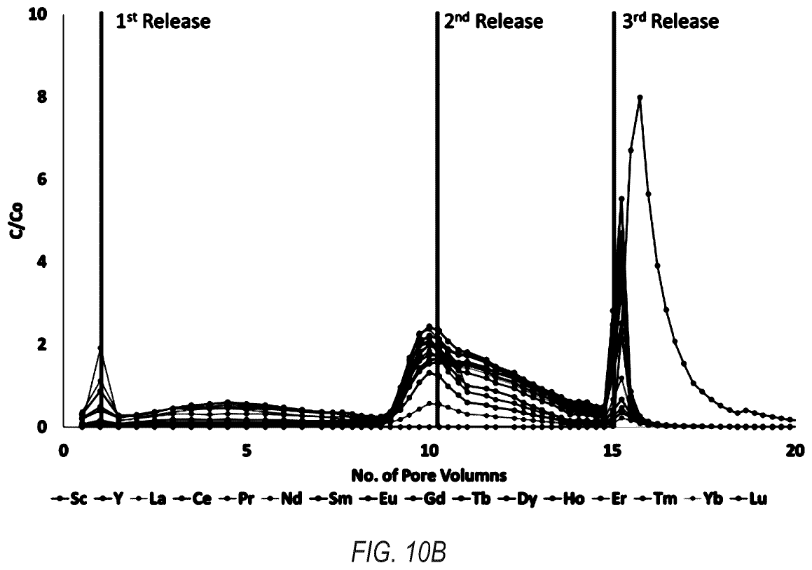

The loading cycle of Column 3 is shown in FIG. 10A, where all elements in the first 6.2 PV were completely sorbed to the media. These solutions were combined and considered an REE-free acid (Basket 0). The release for Col. 3 is shown in FIG. 10B, which was conducted at three pH units 1.6, 0.98, and 0.2. The release was highly affected by the pH of the solution. More REEs were released at lower pH, which is shown in the second peak in FIG. 10B. Solution pH of 1.6 resulted in little release, and pH 0.98 released most of the REEs except for Sc. At pH 0.2, more than 90% of the total Sc in the column was released. Starting the release with pH 1.6 led to releasing some of the light elements (La, Ce, Pr, and Nd) and Y. Although the concentrations were already low, this led to enrichment in some of the HREEs, especially Tb and Dy. During the release at pH 1.6, the percentage of La ranged from 4.63 to 9.14% and the percentage of Dy was between 5.1 and 6.66%, but at pH 0.98, the percentage of La ranged from 0.4 to 0.13% and Dy ranged from 8.93 to 18.29%.

### Columns 4, 5 and 6

The injection solutions for Col. 4, 5 and 6 were different combined fractions that resulted from the loading cycle of Col. 1 (Sol. 1 Fr2, Sol. 1 Fr3, and Sol. 1 Fr4, respectively). A volume difference between the collected solution fractions (Sol. 1 Fr2 to Sol. 1 Fr3) and the influents for Col. 4, 5, and 6 was noticed, the error between what was collected from Col. 1 and was pumped through Col. 4, 5 and 6 ranged from 8 to 12%. FIG. 8 showed the three solutions including the concentration of REEs, and the common thing between all three solutions is that they are almost free of Sc and Th. With these absences, they can be considered mildly enriched because of the elimination of two elements out of the 17 elements. Sol. 1 Fr2 is the influent for Col. 4, Sol. 1 Fr3 is the influent for Col. 5, and Sol. 1 Fr4 is the influent for Col. 6.

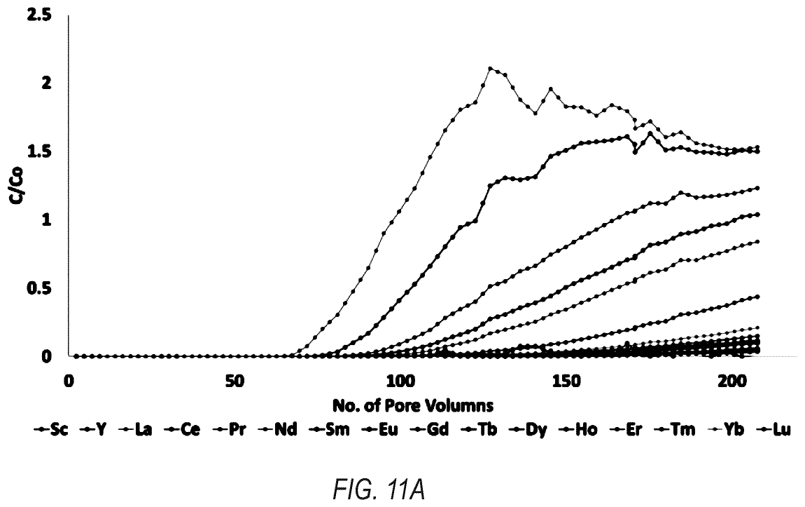

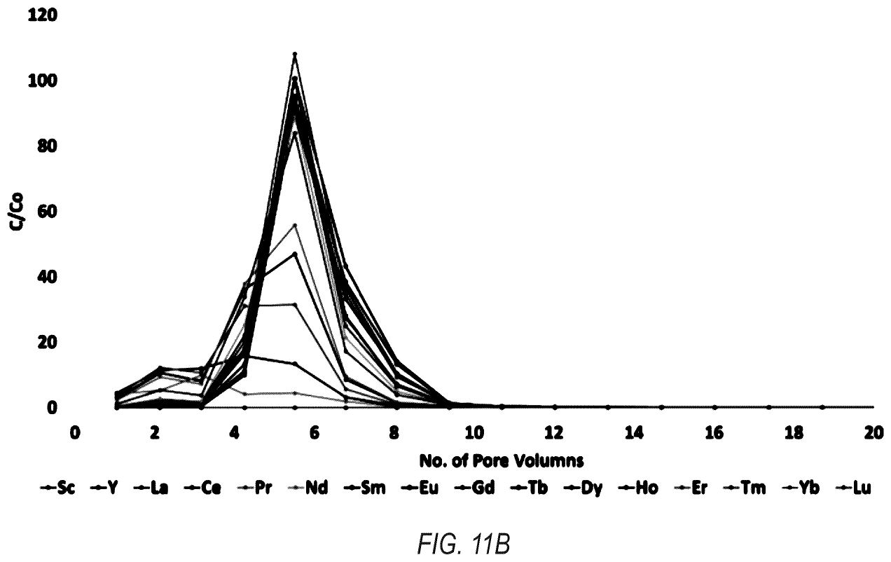

Loading of Col. 4 (FIG. 1A) shows that until PV 68, all REEs sorbed to the media. From PV 68-210, HREEs were sorbing on the account of LREEs. The release of Col. 4 (FIG. 11B) was conducted at pH 1.8 (PV 0 to PV 2.1), pH 1 (PV 2.1 to 4.2 PV), and pH 0.5 (PV 5.5 to PV 31). The tight range of releases was not enough to draw conclusions on the effect of pH variation for this column, but it is clear from the graph that the lowest pH value (pH 0.5) results in the largest recovery peak.

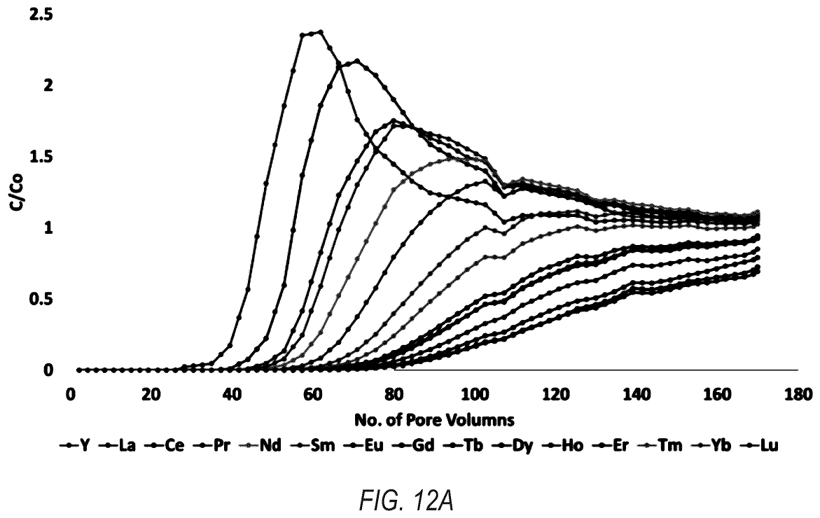

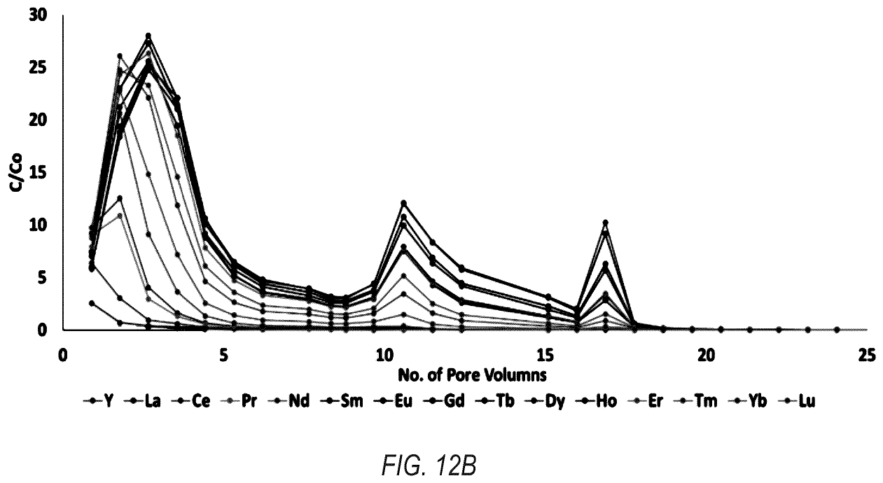

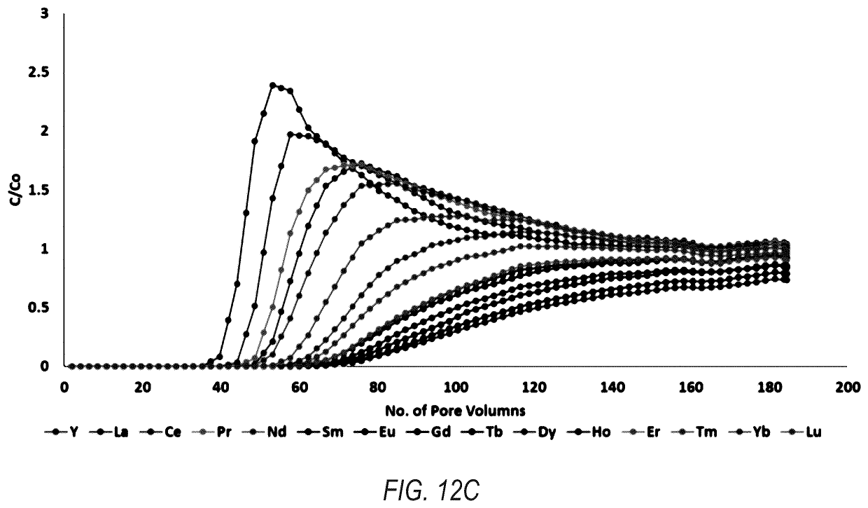

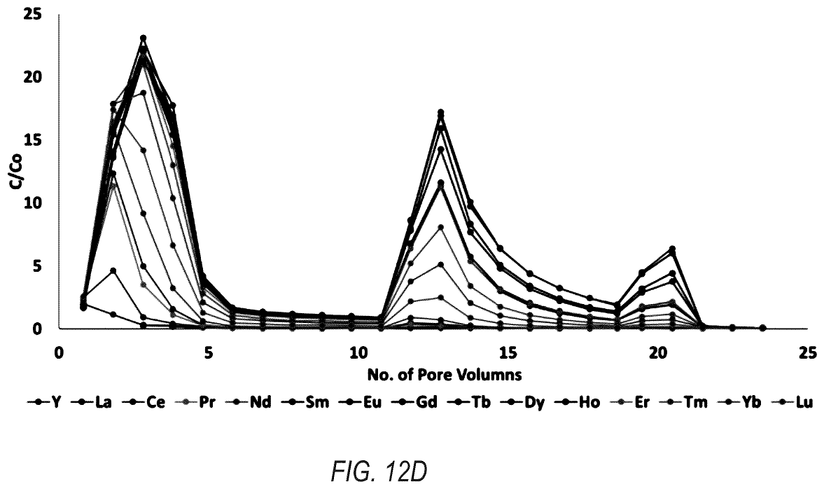

Breakthrough curves for Col. 5 and 6 are shown in FIGS. 12A-12D. Despite the volume and concentration differences between the two columns, the cycles are similar. All REEs in solution are sorbed to the media for the first 40 PV (FIGS. 12A and 12C). After PV 40, LREEs begin desorbing and are concentrated in the collected fractions. The similarity of these two columns in the loading and the release cycle shown in FIGS. 12A-12D arises from the similar concentrations of REEs in both solutions, despite their volume difference. Similar results could have been achieved if the two influent solutions were mixed and put through one column. During the release cycle (FIGS. 12B and 12D), REEs released at pH 1.49 gradually decreased. However, decreasing the pH less than 0.5 led to a spike in release.

### Enriched Baskets

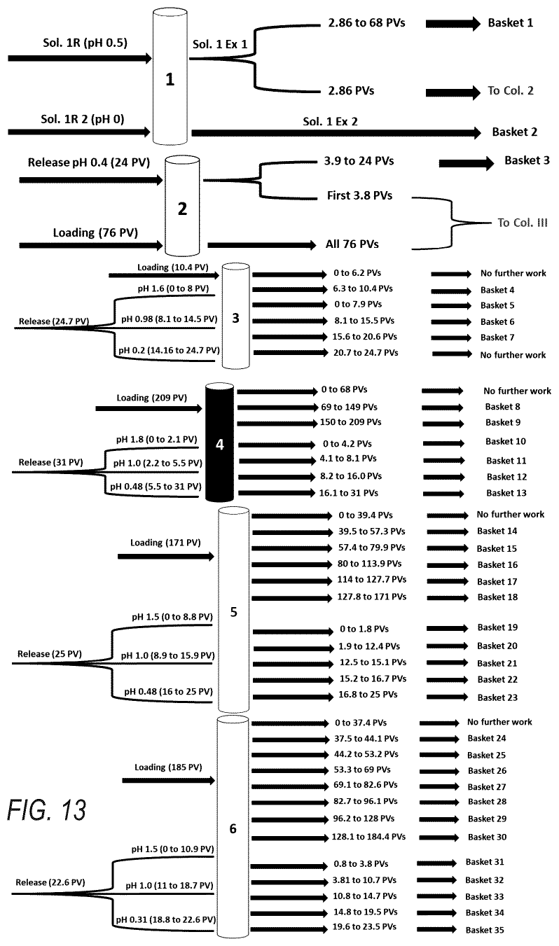

FIG. 13 shows baskets (fractions with similar concentrations) collected from the different columns. The first set of baskets are related to the released pore volumes collected from Col. 1 (Sol. 1 Ex1 and Sol. 1 Ex2), which were enriched in Sc and Th, respectively. The first 2.86 PVs of Sol. 1 Ex1 were used as influent for Col. 2, and the rest of the PVs until PV 68 were mixed and called Basket 1 (enriched Sc). Basket 2 is the mixed PVs resulting from the release cycle of Col. 1 at pH 0.03 (Sol. 1 Ex2). The rest of the Baskets are collected from columns 2, 3, 4, 5, and 6 during the loading and release cycles as shown in FIG. 13.

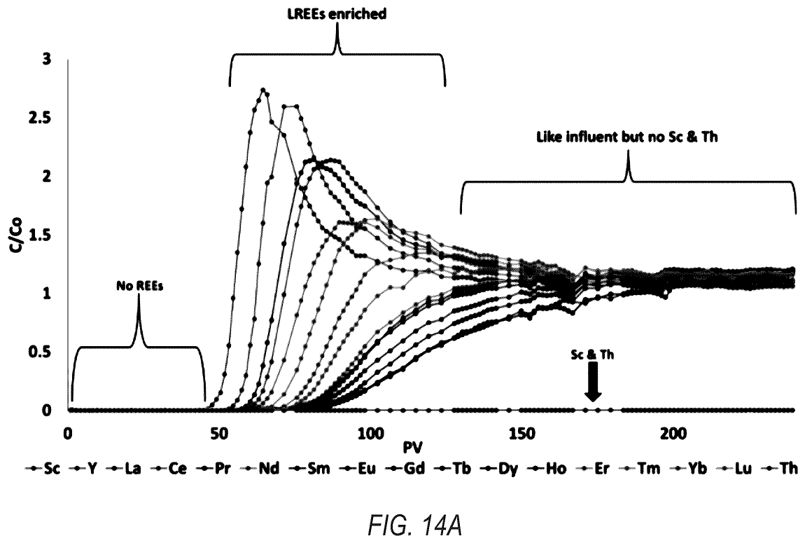

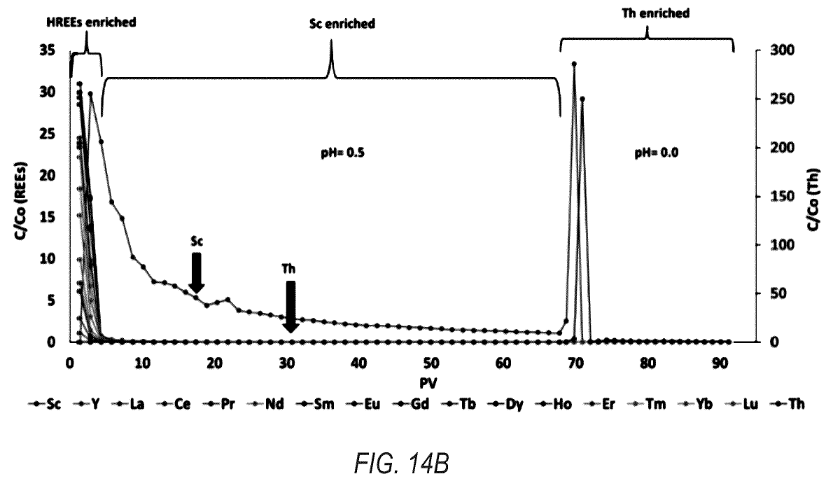

For each column, several baskets were mixed using fractions from the loadings and the release cycles. The process of choosing the baskets was based on the concentration of REEs in the collected test tubes. The concentration of a certain element or groups of elements changes gradually in the samples collected in the loading cycle, therefore the mixing criteria were not optimized but rather dependent on measurements. An example of a typical split from a column can be seen in FIG. 14A, showing an example of fractions enrichment from a loading cycle, and FIG. 14B, showing an example of fractions enrichment from a two-pH release cycle. While the example demonstrates the general approach, different columns yield different results based on the influent solution and the amount of media, so the grouping could have been done differently. The solutions that are free of REEs+Th occur at the beginning of the loading cycle when the sorbent media has excess capacity, and all aqueous metals are binding to the media. A basket was not assigned for it because no further work will take place, similarly if a collection of samples had low total TREEs (<5 ppm), no basket was assigned to them, and it should be mixed with other similar solutions for later work that is not covered here.

TABLE 3, below, shows the important information regarding the 35 Baskets collected from the six columns, the table shows the Basket number, volume in ml, the concentration of REEs+Th in ppm, percentage of enrichment in each basket, and finally the last column of the table shows the mass percentage of total calculated by the equation:

$$Mass percentage of total = \frac{Metal concentration ( ppm ) * Basket Vol . ( L )}{Mass of metal in Col . I influent} * 100$$

where the mass of metal in Column 1 influent is the mass (mg) of individual elements in the initial solution (Solution 1) that had an equal amount of REEs+Th and a total of 1.617 L.

TABLE 3

| | | Concentration | Percentage | Vol. | Amount | Mass Percentage |
|---|---|---|---|---|---|---|
| Basket No. | Element | (ppm) | of Enrichment | (ml) | (mg) | of total |
| Basket 1 | Sc | 29.19 | 92.05% | 28 | 8.3E+00 | 73.05% |
| | Y | 0.05 | 0.16% | | 1.4E−02 | 0.13% |
| | La | 0.02 | 0.07% | | 6.2E−03 | 0.06% |
| | Ce | 0.04 | 0.11% | | 1.0E−02 | 0.09% |
| | Pr | 0.05 | 0.16% | | 1.5E−02 | 0.13% |
| | Nd | 0.08 | 0.24% | | 2.1E−02 | 0.19% |
| | Sm | 0.19 | 0.61% | | 5.5E−02 | 0.48% |
| | Eu | 0.25 | 0.79% | | 7.1E−02 | 0.63% |
| | Gd | 0.21 | 0.65% | | 5.9E−02 | 0.51% |
| | Tb | 0.29 | 0.93% | | 8.4E−02 | 0.75% |
| | Dy | 0.31 | 0.98% | | 8.8E−02 | 0.77% |
| | Ho | 0.26 | 0.82% | | 7.4E−02 | 0.66% |
| | Er | 0.22 | 0.68% | | 6.1E−02 | 0.54% |
| | Tm | 0.18 | 0.56% | | 5.1E−02 | 0.45% |
| | Yb | 0.14 | 0.46% | | 4.1E−02 | 0.37% |
| | Lu | 0.11 | 0.33% | | 3.0E−02 | 0.27% |
| | Th | 0.13 | 0.41% | | 3.7E−02 | 0.33% |
| | Total | 31.71 | | | | |
| Basket 2 | Sc | 12.25 | 12.15% | 102 | 1.3E+00 | 11.02% |
| | Y | 0.00 | 0.00% | | 2.7E−04 | 0.00% |
| | La | 0.01 | 0.01% | | 1.0E−03 | 0.01% |
| | Ce | 0.01 | 0.01% | | 6.4E−04 | 0.01% |
| | Pr | 0.00 | 0.00% | | 4.9E−04 | 0.00% |
| | Nd | 0.00 | 0.00% | | 1.6E−04 | 0.00% |
| | Sm | 0.01 | 0.01% | | 1.0E−03 | 0.01% |
| | Eu | 0.01 | 0.01% | | 1.3E−03 | 0.01% |
| | Gd | 0.01 | 0.01% | | 9.1E−04 | 0.01% |
| | Tb | 0.01 | 0.01% | | 1.4E−03 | 0.01% |
| | Dy | 0.01 | 0.01% | | 1.5E−03 | 0.01% |
| | Ho | 0.01 | 0.01% | | 1.2E−03 | 0.01% |
| | Er | 0.01 | 0.01% | | 1.0E−03 | 0.01% |
| | Tm | 0.01 | 0.01% | | 7.7E−04 | 0.01% |
| | Yb | 0.01 | 0.01% | | 6.5E−04 | 0.01% |
| | Lu | 0.00 | 0.00% | | 4.5E−04 | 0.00% |
| | Th | 88.45 | 87.72% | | 9.0E+00 | 81.09% |
| | Total | 100.83 | | | | |
| Basket 3 | Sc | 15.80 | 40.59% | 2 | 3.8E−02 | 0.34% |
| | Y | 0.29 | 0.74% | | 6.9E−04 | 0.01% |
| | La | 0.05 | 0.12% | | 1.1E−04 | 0.00% |
| | Ce | 0.11 | 0.29% | | 2.7E−04 | 0.00% |
| | Pr | 0.27 | 0.70% | | 6.6E−04 | 0.01% |
| | Nd | 0.50 | 1.28% | | 1.2E−03 | 0.01% |
| | Sm | 2.12 | 5.44% | | 5.1E−03 | 0.04% |
| | Eu | 2.94 | 7.56% | | 7.1E−03 | 0.06% |
| | Gd | 2.03 | 5.20% | | 4.9E−03 | 0.04% |
| | Tb | 3.18 | 8.18% | | 7.7E−03 | 0.07% |
| | Dy | 3.30 | 8.47% | | 8.0E−03 | 0.07% |
| | Ho | 2.48 | 6.38% | | 6.0E−03 | 0.05% |
| | Er | 2.03 | 5.22% | | 4.9E−03 | 0.04% |
| | Tm | 1.58 | 4.07% | | 3.8E−03 | 0.03% |
| | Yb | 1.34 | 3.44% | | 3.2E−03 | 0.03% |
| | Lu | 0.89 | 2.28% | | 2.1E−03 | 0.02% |
| | Th | 0.02 | 0.05% | | 4.6E−05 | 0.00% |
| | Total | 38.93 | | | | |
| Basket 4 | Sc | 0.02 | 0.04% | 5 | 9.8E−05 | 0.00% |
| | Y | 5.15 | 9.54% | | 2.4E−02 | 0.21% |
| | La | 3.55 | 6.57% | | 1.6E−02 | 0.15% |
| | Ce | 4.37 | 8.10% | | 2.0E−02 | 0.18% |
| | Pr | 5.16 | 9.57% | | 2.4E−02 | 0.22% |
| | Nd | 14.06 | 26.05% | | 6.5E−02 | 0.58% |
| | Sm | 2.50 | 4.63% | | 1.1E−02 | 0.10% |
| | Eu | 1.90 | 3.53% | | 8.8E−03 | 0.08% |
| | Gd | 2.52 | 4.68% | | 1.2E−02 | 0.10% |
| | Tb | 1.63 | 3.02% | | 7.5E−03 | 0.06% |
| | Dy | 1.66 | 3.07% | | 7.6E−03 | 0.07% |
| | Ho | 1.90 | 3.52% | | 8.7E−03 | 0.08% |
| | Er | 2.19 | 4.07% | | 1.0E−02 | 0.09% |
| | Tm | 2.45 | 4.54% | | 1.1E−02 | 0.10% |
| | Yb | 2.40 | 4.45% | | 1.1E−02 | 0.10% |
| | Lu | 2.50 | 4.63% | | 1.1E−02 | 0.10% |
| | Th | 0.00 | 0.00% | | 0.0E+00 | 0.00% |
| | Total | 53.95 | | | | |
| Basket 5 | Sc | 0.01 | 0.01% | 9 | 1.1E−04 | 0.00% |
| | Y | 8.58 | 6.97% | | 7.4E−02 | 0.65% |
| | La | 1.47 | 1.20% | | 1.3E−02 | 0.11% |
| | Ce | 3.77 | 3.07% | | 3.3E−02 | 0.29% |
| | Pr | 7.61 | 6.18% | | 6.6E−02 | 0.60% |
| | Nd | 15.43 | 12.53% | | 1.3E−01 | 1.19% |
| | Sm | 10.38 | 8.43% | | 9.0E−02 | 0.78% |
| | Eu | 8.35 | 6.79% | | 7.2E−02 | 0.63% |
| | Gd | 10.11 | 8.21% | | 8.7E−02 | 0.78% |
| | Tb | 7.20 | 5.85% | | 6.2E−02 | 0.54% |
| | Dy | 6.86 | 5.57% | | 5.9E−02 | 0.53% |
| | Ho | 8.09 | 6.58% | | 7.0E−02 | 0.61% |
| | Er | 8.84 | 7.18% | | 7.6E−02 | 0.69% |
| | Tm | 9.32 | 7.57% | | 8.1E−02 | 0.71% |
| | Yb | 8.70 | 7.07% | | 7.5E−02 | 0.66% |
| | Lu | 8.34 | 6.78% | | 7.2E−02 | 0.64% |
| | Th | 0.00 | 0.00% | | 0.0E+00 | 0.00% |
| | Total | 123.08 | | | | |
| Basket 6 | Sc | 19.48 | 1.34% | 8 | 1.6E−01 | 1.43% |
| | Y | 16.55 | 1.14% | | 1.4E−01 | 1.24% |
| | La | 0.83 | 0.06% | | 6.9E−03 | 0.06% |
| | Ce | 3.58 | 0.25% | | 3.0E−02 | 0.27% |
| | Pr | 11.38 | 0.78% | | 9.5E−02 | 0.85% |
| | Nd | 32.39 | 2.23% | | 2.7E−01 | 2.36% |
| | Sm | 133.11 | 9.17% | | 1.1E+00 | 9.68% |
| | Eu | 175.72 | 12.11% | | 1.5E+00 | 13.07% |
| | Gd | 135.09 | 9.31% | | 1.1E+00 | 9.75% |
| | Tb | 194.39 | 13.39% | | 1.6E+00 | 14.60% |
| | Dy | 202.15 | 13.93% | | 1.7E+00 | 14.76% |
| | Ho | 160.80 | 11.08% | | 1.3E+00 | 12.06% |
| | Er | 131.51 | 9.06% | | 1.1E+00 | 9.71% |
| | Tm | 100.50 | 6.92% | | 8.4E−01 | 7.38% |
| | Yb | 80.28 | 5.53% | | 6.7E−01 | 5.95% |
| | Lu | 53.72 | 3.70% | | 4.5E−01 | 3.99% |
| | Th | 0.00 | 0.00% | | 0.0E+00 | 0.00% |
| | Total | 1451.48 | | | | |
| Basket 7 | Sc | 94.80 | 74.85% | 6 | 5.3E−01 | 4.69% |
| | Y | 0.53 | 0.41% | | 2.9E−03 | 0.03% |
| | La | 0.05 | 0.04% | | 3.0E−04 | 0.00% |
| | Ce | 0.15 | 0.12% | | 8.3E−04 | 0.01% |
| | Pr | 0.32 | 0.26% | | 1.8E−03 | 0.02% |
| | Nd | 0.75 | 0.59% | | 4.2E−03 | 0.04% |
| | Sm | 2.33 | 1.84% | | 1.3E−02 | 0.11% |
| | Eu | 3.29 | 2.60% | | 1.8E−02 | 0.16% |
| | Gd | 2.42 | 1.91% | | 1.4E−02 | 0.12% |
| | Tb | 3.96 | 3.13% | | 2.2E−02 | 0.20% |
| | Dy | 4.27 | 3.37% | | 2.4E−02 | 0.21% |
| | Ho | 3.48 | 2.75% | | 2.0E−02 | 0.18% |
| | Er | 3.03 | 2.39% | | 1.7E−02 | 0.15% |
| | Tm | 2.72 | 2.14% | | 1.5E−02 | 0.13% |
| | Yb | 2.55 | 2.02% | | 1.4E−02 | 0.13% |
| | Lu | 2.02 | 1.59% | | 1.1E−02 | 0.10% |
| | Th | 0.00 | 0.00% | | 0.0E+00 | 0.00% |
| | Total | 126.66 | | | | |
| Basket 8 | Sc | 0.00 | 0.00% | 116 | 7.2E−06 | 0.00% |
| | Y | 1.36 | 5.55% | | 1.6E−01 | 1.42% |
| | La | 12.59 | 51.48% | | 1.5E+00 | 12.97% |
| | Ce | 6.81 | 27.86% | | 7.9E−01 | 7.17% |
| | Pr | 2.66 | 10.89% | | 3.1E−01 | 2.76% |
| | Nd | 0.75 | 3.07% | | 8.7E−02 | 0.76% |
| | Sm | 0.01 | 0.02% | | 6.9E−04 | 0.01% |
| | Eu | 0.00 | 0.01% | | 3.7E−04 | 0.00% |
| | Gd | 0.04 | 0.15% | | 4.3E−03 | 0.04% |
| | Tb | 0.00 | 0.01% | | 3.9E−04 | 0.00% |
| | Dy | 0.00 | 0.01% | | 3.8E−04 | 0.00% |
| | Ho | 0.00 | 0.02% | | 5.5E−04 | 0.00% |
| | Er | 0.01 | 0.04% | | 1.1E−03 | 0.01% |
| | Tm | 0.02 | 0.08% | | 2.4E−03 | 0.02% |
| | Yb | 0.04 | 0.17% | | 4.8E−03 | 0.04% |
| | Lu | 0.15 | 0.63% | | 1.8E−02 | 0.16% |
| | Th | 0.00 | 0.00% | | 1.1E−05 | 0.00% |
| | Total | 24.45 | | | | |
| | Vol. ml | 116.00 | | | | |
| Basket 9 | Sc | 0.00 | 0.00% | 116 | 3.6E−05 | 0.00% |
| | Y | 7.09 | 12.59% | | 5.9E−01 | 5.35% |
| | La | 16.49 | 29.29% | | 1.4E+00 | 12.29% |
| | Ce | 14.89 | 26.45% | | 1.2E+00 | 11.33% |
| | Pr | 10.09 | 17.93% | | 8.5E−01 | 7.56% |
| | Nd | 4.79 | 8.51% | | 4.0E−01 | 3.51% |
| | Sm | 0.10 | 0.18% | | 8.5E−03 | 0.07% |
| | Eu | 0.03 | 0.05% | | 2.2E−03 | 0.02% |
| | Gd | 0.15 | 0.26% | | 1.2E−02 | 0.11% |
| | Tb | 0.02 | 0.03% | | 1.6E−03 | 0.01% |
| | Dy | 0.02 | 0.03% | | 1.4E−03 | 0.01% |
| | Ho | 0.05 | 0.09% | | 4.0E−03 | 0.04% |
| | Er | 0.12 | 0.21% | | 9.7E−03 | 0.09% |
| | Tm | 0.28 | 0.51% | | 2.4E−02 | 0.21% |
| | Yb | 0.54 | 0.96% | | 4.5E−02 | 0.40% |
| | Lu | 1.64 | 2.92% | | 1.4E−01 | 1.22% |
| | Th | 0.00 | 0.00% | | 0.0E+00 | 0.00% |
| | Total | 56.30 | | | | |
| | Vol. ml | 83.85 | | | | |
| Basket 10 | Sc | 0.00 | 0.00% | 6 | 0.0E+00 | 0.00% |
| | Y | 125.82 | 17.92% | | 7.5E−01 | 6.75% |
| | La | 58.18 | 8.29% | | 3.5E−01 | 3.08% |
| | Ce | 106.41 | 15.15% | | 6.3E−01 | 5.76% |
| | Pr | 133.65 | 19.03% | | 8.0E−01 | 7.12% |
| | Nd | 108.46 | 15.45% | | 6.5E−01 | 5.65% |
| | Sm | 9.42 | 1.34% | | 5.6E−02 | 0.49% |
| | Eu | 3.53 | 0.50% | | 2.1E−02 | 0.19% |
| | Gd | 11.77 | 1.68% | | 7.0E−02 | 0.61% |
| | Tb | 2.45 | 0.35% | | 1.5E−02 | 0.13% |
| | Dy | 2.52 | 0.36% | | 1.5E−02 | 0.13% |
| | Ho | 5.75 | 0.82% | | 3.4E−02 | 0.31% |
| | Er | 11.29 | 1.61% | | 6.7E−02 | 0.60% |
| | Tm | 21.94 | 3.12% | | 1.3E−01 | 1.15% |
| | Yb | 34.31 | 4.89% | | 2.0E−01 | 1.82% |
| | Lu | 66.69 | 9.50% | | 4.0E−01 | 3.53% |
| | Th | 0.00 | 0.00% | | 0.0E+00 | 0.00% |
| | Total | 702.17 | | | | |
| | Vol. ml | 5.96 | | | | |
| Basket 11 | Sc | 0.00 | 0.00% | 5 | 0.0E+00 | 0.00% |
| | Y | 162.12 | 10.67% | | 8.7E−01 | 7.81% |
| | La | 22.11 | 1.46% | | 1.2E−01 | 1.05% |
| | Ce | 54.85 | 3.61% | | 2.9E−01 | 2.67% |
| | Pr | 115.66 | 7.61% | | 6.2E−01 | 5.54% |
| | Nd | 167.02 | 10.99% | | 9.0E−01 | 7.82% |
| | Sm | 88.41 | 5.82% | | 4.7E−01 | 4.13% |
| | Eu | 53.01 | 3.49% | | 2.8E−01 | 2.53% |
| | Gd | 87.00 | 5.73% | | 4.7E−01 | 4.03% |
| | Tb | 42.34 | 2.79% | | 2.3E−01 | 2.04% |
| | Dy | 41.72 | 2.75% | | 2.2E−01 | 1.96% |
| | Ho | 68.45 | 4.51% | | 3.7E−01 | 3.30% |
| | Er | 98.50 | 6.48% | | 5.3E−01 | 4.67% |
| | Tm | 141.03 | 9.28% | | 7.6E−01 | 6.65% |
| | Yb | 169.52 | 11.16% | | 9.1E−01 | 8.07% |
| | Lu | 207.42 | 13.65% | | 1.1E+00 | 9.88% |
| | Th | 0.00 | 0.00% | | 0.0E+00 | 0.00% |
| | Total | 1519.17 | | | | |
| | Vol. ml | 5.36 | | | | |
| Basket 12 | Sc | 0.00 | 0.00% | 11 | 0.0E+00 | 0.00% |
| | Y | 1.79 | 11.64% | | 2.0E−02 | 0.18% |
| | La | 0.68 | 4.45% | | 7.6E−03 | 0.07% |
| | Ce | 1.03 | 6.69% | | 1.1E−02 | 0.10% |
| | Pr | 1.47 | 9.55% | | 1.6E−02 | 0.15% |
| | Nd | 1.63 | 10.60% | | 1.8E−02 | 0.16% |
| | Sm | 0.69 | 4.49% | | 7.7E−03 | 0.07% |
| | Eu | 0.44 | 2.84% | | 4.9E−03 | 0.04% |
| | Gd | 0.71 | 4.60% | | 7.9E−03 | 0.07% |
| | Tb | 0.37 | 2.42% | | 4.2E−03 | 0.04% |
| | Dy | 0.38 | 2.45% | | 4.2E−03 | 0.04% |
| | Ho | 0.59 | 3.86% | | 6.6E−03 | 0.06% |
| | Er | 0.86 | 5.56% | | 9.5E−03 | 0.08% |
| | Tm | 1.23 | 7.99% | | 1.4E−02 | 0.12% |
| | Yb | 1.53 | 9.98% | | 1.7E−02 | 0.15% |
| | Lu | 1.98 | 12.86% | | 2.2E−02 | 0.20% |
| | Th | 0.00 | 0.02% | | 3.1E−05 | 0.00% |
| | Total | 15.38 | | | | |
| | Vol. ml | 11.17 | | | | |
| Basket 13 | Sc | 0.00 | 0.04% | 21 | 2.6E−05 | 0.00% |
| | Y | 0.33 | 10.93% | | 6.9E−03 | 0.06% |
| | La | 0.14 | 4.65% | | 2.9E−03 | 0.03% |
| | Ce | 0.23 | 7.77% | | 4.9E−03 | 0.04% |
| | Pr | 0.32 | 10.46% | | 6.6E−03 | 0.06% |
| | Nd | 0.33 | 11.02% | | 6.9E−03 | 0.06% |
| | Sm | 0.14 | 4.72% | | 3.0E−03 | 0.03% |
| | Eu | 0.08 | 2.74% | | 1.7E−03 | 0.02% |
| | Gd | 0.13 | 4.35% | | 2.7E−03 | 0.02% |
| | Tb | 0.06 | 2.11% | | 1.3E−03 | 0.01% |
| | Dy | 0.06 | 2.10% | | 1.3E−03 | 0.01% |
| | Ho | 0.11 | 3.51% | | 2.2E−03 | 0.02% |
| | Er | 0.16 | 5.20% | | 3.3E−03 | 0.03% |
| | Tm | 0.24 | 7.96% | | 5.0E−03 | 0.04% |
| | Yb | 0.29 | 9.48% | | 5.9E−03 | 0.05% |
| | Lu | 0.39 | 12.98% | | 8.1E−03 | 0.07% |
| | Th | 0.00 | 0.00% | | 0.0E+00 | 0 |
| | Total | 3.02 | | | | |
| | Vol. ml | 20.70 | | | | |
| Basket 14 | Sc | 0.00 | 0.01% | 31 | 3.2E−05 | 0.00% |
| | Y | 0.65 | 3.79% | | 2.0E−02 | 0.18% |
| | La | 11.13 | 64.46% | | 3.4E−01 | 3.02% |
| | Ce | 3.95 | 22.86% | | 1.2E−01 | 1.09% |
| | Pr | 1.13 | 6.54% | | 3.4E−02 | 0.31% |
| | Nd | 0.27 | 1.59% | | 8.4E−03 | 0.07% |
| | Sm | 0.00 | 0.01% | | 7.5E−05 | 0.00% |
| | Eu | 0.00 | 0.00% | | 1.6E−05 | 0.00% |
| | Gd | 0.02 | 0.09% | | 4.9E−04 | 0.00% |
| | Tb | 0.00 | 0.00% | | 0.0E+00 | 0.00% |
| | Dy | 0.00 | 0.01% | | 4.2E−05 | 0.00% |
| | Ho | 0.00 | 0.01% | | 3.8E−05 | 0.00% |
| | Er | 0.00 | 0.02% | | 9.8E−05 | 0.00% |
| | Tm | 0.01 | 0.05% | | 2.8E−04 | 0.00% |
| | Yb | 0.02 | 0.12% | | 6.3E−04 | 0.01% |
| | Lu | 0.08 | 0.44% | | 2.3E−03 | 0.02% |
| | Th | 0.00 | 0.00% | | 0.0E+00 | 0.00% |
| | Total | 17.26 | | | | |
| | Vol. ml | 30.55 | | | | |
| Basket 15 | Sc | 0.00 | 0.00% | 38 | 2.1E−05 | 0.00% |
| | Y | 10.64 | 14.98% | | 4.0E−01 | 3.60% |
| | La | 17.16 | 24.16% | | 5.9E−01 | 5.22% |
| | Ce | 17.52 | 24.67% | | 6.3E−01 | 5.71% |
| | Pr | 12.22 | 17.21% | | 4.6E−01 | 4.07% |
| | Nd | 6.47 | 9.11% | | 2.5E−01 | 2.14% |
| | Sm | 0.26 | 0.37% | | 1.0E−02 | 0.09% |
| | Eu | 0.09 | 0.12% | | 3.3E−03 | 0.03% |
| | Gd | 0.37 | 0.52% | | 1.4E−02 | 0.12% |
| | Tb | 0.06 | 0.09% | | 2.4E−03 | 0.02% |
| | Dy | 0.08 | 0.11% | | 2.9E−03 | 0.03% |
| | Ho | 0.16 | 0.22% | | 5.9E−03 | 0.05% |
| | Er | 0.34 | 0.49% | | 1.3E−02 | 0.12% |
| | Tm | 0.81 | 1.14% | | 3.1E−02 | 0.27% |
| | Yb | 1.40 | 1.97% | | 5.3E−02 | 0.47% |
| | Lu | 3.45 | 4.86% | | 1.3E−01 | 1.17% |
| | Th | 0.00 | 0.00% | | 5.5E−05 | 0.00% |
| | Total | 71.03 | | | | |
| | Vol. ml | 38.42 | | | | |
| Basket 16 | Sc | 0.00 | 0.00% | 58 | 4.3E−05 | 0.00% |
| | Y | 13.74 | 13.70% | | 8.0E−01 | 7.17% |
| | La | 9.53 | 9.50% | | 5.5E−01 | 4.91% |
| | Ce | 11.97 | 11.94% | | 6.9E−01 | 6.30% |
| | Pr | 13.37 | 13.34% | | 7.8E−01 | 6.93% |
| | Nd | 12.55 | 12.52% | | 7.3E−01 | 6.36% |
| | Sm | 2.95 | 2.95% | | 1.7E−01 | 1.49% |
| | Eu | 1.40 | 1.40% | | 8.2E−02 | 0.73% |
| | Gd | 2.93 | 2.93% | | 1.7E−01 | 1.47% |
| | Tb | 1.02 | 1.01% | | 5.9E−02 | 0.53% |
| | Dy | 0.97 | 0.97% | | 5.6E−02 | 0.49% |
| | Ho | 2.04 | 2.04% | | 1.2E−01 | 1.06% |
| | Er | 3.35 | 3.34% | | 1.9E−01 | 1.72% |
| | Tm | 5.88 | 5.87% | | 3.4E−01 | 3.00% |
| | Yb | 7.41 | 7.39% | | 4.3E−01 | 3.82% |
| | Lu | 11.12 | 11.09% | | 6.4E−01 | 5.73% |
| | Th | 0.00 | 0.00% | | 2.0E−04 | 0.00% |
| | Total | 100.25 | | | | |
| | Vol. ml | 58.02 | | | | |
| Basket 17 | Sc | 0.00 | 0.00% | 23 | 8.6E−06 | 0.00% |
| | Y | 11.30 | 10.06% | | 2.6E−01 | 2.36% |
| | La | 8.69 | 7.74% | | 2.0E−01 | 1.80% |
| | Ce | 9.98 | 8.89% | | 2.3E−01 | 2.11% |
| | Pr | 11.05 | 9.84% | | 2.6E−01 | 2.30% |
| | Nd | 11.40 | 10.15% | | 2.7E−01 | 2.32% |
| | Sm | 5.66 | 5.04% | | 1.3E−01 | 1.15% |
| | Eu | 3.29 | 2.93% | | 7.7E−02 | 0.68% |
| | Gd | 5.48 | 4.88% | | 1.3E−01 | 1.10% |
| | Tb | 2.55 | 2.27% | | 5.9E−02 | 0.53% |
| | Dy | 2.33 | 2.08% | | 5.4E−02 | 0.48% |
| | Ho | 4.38 | 3.90% | | 1.0E−01 | 0.92% |
| | Er | 6.04 | 5.38% | | 1.4E−01 | 1.24% |
| | Tm | 8.79 | 7.83% | | 2.0E−01 | 1.80% |
| | Yb | 9.70 | 8.64% | | 2.3E−01 | 2.00% |
| | Lu | 11.68 | 10.40% | | 2.7E−01 | 2.42% |
| | Th | 0.00 | 0.00% | | 1.1E−04 | 0.00% |
| | Total | 112.33 | | | | |
| | Vol. ml | 23.28 | | | | |
| Basket 18 | Sc | 0.00 | 0.00% | 74 | 7.9E−05 | 0.00% |
| | Y | 9.94 | 8.68% | | 1.5E+00 | 13.15% |
| | La | 8.37 | 7.31% | | 1.2E+00 | 10.95% |
| | Ce | 8.87 | 7.74% | | 1.3E+00 | 11.84% |
| | Pr | 9.91 | 8.65% | | 1.5E+00 | 13.02% |
| | Nd | 10.14 | 8.85% | | 1.5E+00 | 13.03% |
| | Sm | 6.90 | 6.03% | | 1.0E+00 | 8.85% |
| | Eu | 4.81 | 4.19% | | 7.1E−01 | 6.30% |
| | Gd | 6.69 | 5.84% | | 9.8E−01 | 8.51% |
| | Tb | 3.97 | 3.47% | | 5.8E−01 | 5.26% |
| | Dy | 3.54 | 3.09% | | 5.2E−01 | 4.56% |
| | Ho | 5.72 | 5.00% | | 8.4E−01 | 7.57% |
| | Er | 6.99 | 6.10% | | 1.0E+00 | 9.09% |
| | Tm | 9.02 | 7.87% | | 1.3E+00 | 11.67% |
| | Yb | 9.31 | 8.13% | | 1.4E+00 | 12.17% |
| | Lu | 10.38 | 9.06% | | 1.5E+00 | 13.58% |
| | Th | 0.01 | 0.01% | | 8.9E−04 | 0.01% |
| | Total | 114.56 | | | | |
| | Vol. ml | 73.59 | | | | |
| Basket 19 | Sc | 0.00 | 0.00% | 3 | 6.1E−04 | 0.01% |
| | Y | 100.67 | 6.47% | | 1.7E−03 | 0.02% |
| | La | 13.10 | 0.84% | | 6.3E−04 | 0.01% |
| | Ce | 38.68 | 2.48% | | 1.0E−03 | 0.01% |
| | Pr | 89.23 | 5.73% | | 1.8E−03 | 0.02% |
| | Nd | 133.09 | 8.55% | | 2.7E−03 | 0.02% |
| | Sm | 121.34 | 7.79% | | 8.1E−03 | 0.07% |
| | Eu | 91.02 | 5.85% | | 1.0E−02 | 0.09% |
| | Gd | 119.92 | 7.70% | | 8.6E−03 | 0.07% |
| | Tb | 80.46 | 5.17% | | 1.2E−02 | 0.10% |
| | Dy | 77.04 | 4.95% | | 1.2E−02 | 0.10% |
| | Ho | 107.47 | 6.90% | | 1.0E−02 | 0.09% |
| | Er | 128.33 | 8.24% | | 8.8E−03 | 0.08% |
| | Tm | 150.42 | 9.66% | | 7.0E−03 | 0.06% |
| | Yb | 154.33 | 9.91% | | 5.6E−03 | 0.05% |
| | Lu | 151.62 | 9.74% | | 4.0E−03 | 0.04% |
| | Th | 0.01 | 0.00% | | 3.7E−04 | 0.00% |
| | Total | 1556.72 | | | | |
| | Vol. ml | 3.01 | | | | |
| Basket 20 | Sc | 0.00 | 0.00% | 3 | 0.0E+00 | 0.00% |
| | Y | 6.05 | 1.07% | | 1.1E−01 | 0.98% |
| | La | 0.77 | 0.14% | | 1.4E−02 | 0.12% |
| | Ce | 1.69 | 0.30% | | 3.1E−02 | 0.28% |
| | Pr | 4.56 | 0.81% | | 8.2E−02 | 0.74% |
| | Nd | 12.74 | 2.26% | | 2.3E−01 | 2.01% |
| | Sm | 62.37 | 11.05% | | 1.1E+00 | 9.82% |
| | Eu | 64.12 | 11.36% | | 1.2E+00 | 10.34% |
| | Gd | 61.07 | 10.82% | | 1.1E+00 | 9.55% |
| | Tb | 60.22 | 10.67% | | 1.1E+00 | 9.80% |
| | Dy | 56.39 | 9.99% | | 1.0E+00 | 8.92% |
| | Ho | 61.89 | 10.97% | | 1.1E+00 | 10.06% |
| | Er | 57.38 | 10.17% | | 1.0E+00 | 9.18% |
| | Tm | 49.94 | 8.85% | | 9.0E−01 | 7.95% |
| | Yb | 40.09 | 7.10% | | 7.3E−01 | 6.44% |
| | Lu | 25.13 | 4.45% | | 4.5E−01 | 4.04% |
| | Th | 0.01 | 0.00% | | 9.2E−05 | 0.00% |
| | Total | 564.41 | | | | |
| Basket 21 | Sc | 0.00 | 0.00% | 5 | 0.0E+00 | 0.00% |
| | Y | 0.23 | 0.21% | | 1.1E−03 | 0.01% |
| | La | 0.04 | 0.03% | | 1.8E−04 | 0.00% |
| | Ce | 0.08 | 0.07% | | 3.6E−04 | 0.00% |
| | Pr | 0.17 | 0.15% | | 7.8E−04 | 0.01% |
| | Nd | 0.35 | 0.31% | | 1.6E−03 | 0.01% |
| | Sm | 9.64 | 8.50% | | 4.4E−02 | 0.39% |
| | Eu | 16.72 | 14.74% | | 7.7E−02 | 0.69% |
| | Gd | 10.76 | 9.48% | | 5.0E−02 | 0.43% |
| | Tb | 20.34 | 17.93% | | 9.4E−02 | 0.84% |
| | Dy | 19.51 | 17.20% | | 9.0E−02 | 0.79% |
| | Ho | 14.82 | 13.07% | | 6.8E−02 | 0.61% |
| | Er | 10.35 | 9.13% | | 4.8E−02 | 0.42% |
| | Tm | 5.78 | 5.09% | | 2.7E−02 | 0.23% |
| | Yb | 3.39 | 2.99% | | 1.6E−02 | 0.14% |
| | Lu | 1.25 | 1.10% | | 5.7E−03 | 0.05% |
| | Th | 0.00 | 0.00% | | 0.0E+00 | 0.00% |
| | Total | 113.42 | | | | |
| | Vol. ml | 4.60 | | | | |
| Basket 22 | Sc | 0.00 | 0.00% | 3 | 1.2E−03 | 0.01% |
| | Y | 0.39 | 0.20% | | 2.1E−04 | 0.00% |
| | La | 0.07 | 0.04% | | 3.8E−04 | 0.00% |
| | Ce | 0.13 | 0.07% | | 7.9E−04 | 0.01% |
| | Pr | 0.26 | 0.14% | | 1.8E−03 | 0.02% |
| | Nd | 0.61 | 0.32% | | 4.3E−02 | 0.37% |
| | Sm | 14.15 | 7.35% | | 8.5E−02 | 0.74% |
| | Eu | 28.02 | 14.55% | | 5.0E−02 | 0.45% |
| | Gd | 16.72 | 8.68% | | 1.1E−01 | 0.95% |
| | Tb | 36.38 | 18.89% | | 1.1E−01 | 1.03% |
| | Dy | 37.75 | 19.60% | | 7.9E−02 | 0.69% |
| | Ho | 26.28 | 13.64% | | 4.9E−02 | 0.44% |
| | Er | 16.37 | 8.50% | | 2.6E−02 | 0.23% |
| | Tm | 8.65 | 4.49% | | 1.5E−02 | 0.13% |
| | Yb | 4.90 | 2.55% | | 5.9E−03 | 0.05% |
| | Lu | 1.95 | 1.01% | | 1.1E−05 | 0.00% |
| | Th | 0.00 | 0.00% | | 0.0E+00 | 0.00% |
| | Total | 192.61 | | | | |
| | Vol. ml | 3.02 | | | | |
| Basket 23 | Sc | 0.04 | 0.02% | 14 | 6.1E−04 | 0.01% |
| | Y | 0.12 | 0.06% | | 1.7E−03 | 0.02% |
| | La | 0.05 | 0.02% | | 6.3E−04 | 0.01% |
| | Ce | 0.08 | 0.04% | | 1.0E−03 | 0.01% |
| | Pr | 0.13 | 0.07% | | 1.8E−03 | 0.02% |
| | Nd | 0.19 | 0.10% | | 2.7E−03 | 0.02% |
| | Sm | 0.58 | 0.30% | | 8.1E−03 | 0.07% |
| | Eu | 0.75 | 0.39% | | 1.0E−02 | 0.09% |
| | Gd | 0.62 | 0.32% | | 8.6E−03 | 0.07% |
| | Tb | 0.83 | 0.43% | | 1.2E−02 | 0.10% |
| | Dy | 0.85 | 0.44% | | 1.2E−02 | 0.10% |
| | Ho | 0.75 | 0.39% | | 1.0E−02 | 0.09% |
| | Er | 0.64 | 0.33% | | 8.8E−03 | 0.08% |
| | Tm | 0.51 | 0.26% | | 7.0E−03 | 0.06% |
| | Yb | 0.40 | 0.21% | | 5.6E−03 | 0.05% |
| | Lu | 0.29 | 0.15% | | 4.0E−03 | 0.04% |
| | Th | 0.03 | 0.01% | | 3.7E−04 | 0.00% |
| | Total | 6.84 | | | | |
| | Vol. ml | 13.90 | | | | |
| Basket 24 | Sc | 0.00 | 0.02% | 23 | 1.3E−05 | 0.00% |
| | Y | 0.00 | 0.00% | | 0.0E+00 | 0.00% |
| | La | 2.93 | 95.93% | | 6.9E−02 | 0.61% |
| | Ce | 0.12 | 4.01% | | 2.9E−03 | 0.03% |
| | Pr | 0.00 | 0.04% | | 2.7E−05 | 0.00% |
| | Nd | 0.00 | 0.00% | | 0.0E+00 | 0.00% |
| | Sm | 0.00 | 0.00% | | 0.0E+00 | 0.00% |
| | Eu | 0.00 | 0.00% | | 0.0E+00 | 0.00% |
| | Gd | 0.00 | 0.00% | | 0.0E+00 | 0.00% |
| | Tb | 0.00 | 0.00% | | 0.0E+00 | 0.00% |
| | Dy | 0.00 | 0.00% | | 0.0E+00 | 0.00% |
| | Ho | 0.00 | 0.00% | | 0.0E+00 | 0.00% |
| | Er | 0.00 | 0.00% | | 0.0E+00 | 0.00% |
| | Tm | 0.00 | 0.00% | | 0.0E+00 | 0.00% |
| | Yb | 0.00 | 0.00% | | 0.0E+00 | 0.00% |
| | Lu | 0.00 | 0.00% | | 0.0E+00 | 0.00% |
| | Th | 0.00 | 0.01% | | 5.2E−06 | 0.00% |
| | Total | 3.05 | | | | |
| | Vol. ml | 23.49 | | | | |
| Basket 25 | Sc | 0.00 | 0.00% | 24 | 1.0E−05 | 0.00% |
| | Y | 0.71 | 2.98% | | 2.2E−02 | 0.20% |
| | La | 14.55 | 61.33% | | 4.6E−01 | 4.09% |
| | Ce | 6.30 | 26.57% | | 2.0E−01 | 1.81% |
| | Pr | 1.79 | 7.55% | | 5.7E−02 | 0.51% |
| | Nd | 0.32 | 1.36% | | 1.0E−02 | 0.09% |
| | Sm | 0.00 | 0.00% | | 0.0E+00 | 0.00% |
| | Eu | 0.00 | 0.00% | | 0.0E+00 | 0.00% |
| | Gd | 0.02 | 0.07% | | 5.6E−04 | 0.00% |
| | Tb | 0.00 | 0.00% | | 1.6E−05 | 0.00% |
| | Dy | 0.00 | 0.00% | | 0.0E+00 | 0.00% |
| | Ho | 0.00 | 0.00% | | 0.0E+00 | 0.00% |
| | Er | 0.00 | 0.00% | | 6.4E−06 | 0.00% |
| | Tm | 0.00 | 0.01% | | 3.9E−05 | 0.00% |
| | Yb | 0.00 | 0.02% | | 1.2E−04 | 0.00% |
| | Lu | 0.03 | 0.11% | | 8.2E−04 | 0.01% |
| | Th | 0.00 | 0.00% | | 3.0E−05 | 0.00% |
| | Total | 23.73 | | | | |
| | Vol. ml | 23.97 | | | | |
| Basket 26 | Sc | 0.00 | 0.00% | 56 | 2.0E−05 | 0.00% |
| | Y | 9.07 | 14.58% | | 5.0E−01 | 4.53% |
| | La | 15.61 | 25.09% | | 8.7E−01 | 7.70% |
| | Ce | 14.98 | 24.09% | | 8.3E−01 | 7.55% |
| | Pr | 11.10 | 17.85% | | 6.2E−01 | 5.51% |
| | Nd | 6.16 | 9.91% | | 3.4E−01 | 2.99% |
| | Sm | 0.23 | 0.37% | | 1.3E−02 | 0.11% |
| | Eu | 0.07 | 0.11% | | 3.9E−03 | 0.03% |
| | Gd | 0.29 | 0.47% | | 1.6E−02 | 0.14% |
| | Tb | 0.05 | 0.08% | | 2.6E−03 | 0.02% |
| | Dy | 0.04 | 0.07% | | 2.3E−03 | 0.02% |
| | Ho | 0.11 | 0.18% | | 6.2E−03 | 0.06% |
| | Er | 0.25 | 0.40% | | 1.4E−02 | 0.12% |
| | Tm | 0.58 | 0.94% | | 3.2E−02 | 0.29% |
| | Yb | 1.04 | 1.67% | | 5.8E−02 | 0.51% |
| | Lu | 2.61 | 4.19% | | 1.4E−01 | 1.29% |
| | Th | 0.00 | 0.00% | | 1.0E−04 | 0.00% |
| | Total | 62.19 | | | | |
| | Vol. ml | 55.57 | | | | |
| Basket 27 | Sc | 0.00 | 0.00% | 48 | 1.4E−05 | 0.00% |
| | Y | 13.58 | 21.84% | | 6.5E−01 | 5.83% |
| | La | 11.93 | 19.19% | | 5.7E−01 | 5.07% |
| | Ce | 13.32 | 21.42% | | 6.4E−01 | 5.77% |
| | Pr | 13.44 | 21.61% | | 6.4E−01 | 5.73% |
| | Nd | 11.93 | 19.19% | | 5.7E−01 | 4.98% |
| | Sm | 2.04 | 3.29% | | 9.8E−02 | 0.85% |
| | Eu | 0.93 | 1.49% | | 4.4E−02 | 0.39% |
| | Gd | 2.00 | 3.21% | | 9.5E−02 | 0.83% |
| | Tb | 0.64 | 1.03% | | 3.1E−02 | 0.27% |
| | Dy | 0.58 | 0.93% | | 2.8E−02 | 0.24% |
| | Ho | 1.24 | 2.00% | | 5.9E−02 | 0.53% |
| | Er | 2.15 | 3.46% | | 1.0E−01 | 0.91% |
| | Tm | 3.87 | 6.22% | | 1.8E−01 | 1.62% |
| | Yb | 5.46 | 8.78% | | 2.6E−01 | 2.32% |
| | Lu | 8.69 | 13.97% | | 4.2E−01 | 3.69% |
| | Th | 0.00 | 0.01% | | 1.7E−04 | 0.00% |
| | Total | 91.81 | | | | |
| | Vol. ml | 47.77 | | | | |
| Basket 28 | Sc | 0.00 | 0.00% | 47 | 2.4E−05 | 0.00% |
| | Y | 12.41 | 11.71% | | 5.9E−01 | 5.28% |
| | La | 9.83 | 9.28% | | 4.6E−01 | 4.13% |
| | Ce | 11.51 | 10.87% | | 5.4E−01 | 4.94% |
| | Pr | 12.10 | 11.42% | | 5.7E−01 | 5.11% |
| | Nd | 11.92 | 11.26% | | 5.6E−01 | 4.92% |
| | Sm | 4.36 | 4.12% | | 2.1E−01 | 1.80% |
| | Eu | 2.55 | 2.40% | | 1.2E−01 | 1.07% |
| | Gd | 4.26 | 4.03% | | 2.0E−01 | 1.74% |
| | Tb | 1.99 | 1.88% | | 9.4E−02 | 0.85% |
| | Dy | 1.75 | 1.65% | | 8.3E−02 | 0.72% |
| | Ho | 3.19 | 3.01% | | 1.5E−01 | 1.36% |
| | Er | 4.53 | 4.28% | | 2.1E−01 | 1.89% |
| | Tm | 6.64 | 6.27% | | 3.1E−01 | 2.76% |
| | Yb | 8.35 | 7.88% | | 3.9E−01 | 3.50% |
| | Lu | 10.53 | 9.94% | | 5.0E−01 | 4.42% |
| | Th | 0.01 | 0.01% | | 2.6E−04 | 0.00% |
| | Total | 105.92 | | | | |
| Basket 29 | Sc | 0.00 | 0.00% | 112 | 3.8E−05 | 0.00% |
| | Y | 10.53 | 9.05% | | 1.2E+00 | 10.59% |
| | La | 8.37 | 7.19% | | 9.4E−01 | 8.31% |
| | Ce | 9.50 | 8.17% | | 1.1E+00 | 9.63% |
| | Pr | 10.19 | 8.76% | | 1.1E+00 | 10.17% |
| | Nd | 10.41 | 8.95% | | 1.2E+00 | 10.17% |
| | Sm | 6.69 | 5.75% | | 7.5E−01 | 6.51% |
| | Eu | 5.08 | 4.36% | | 5.7E−01 | 5.06% |
| | Gd | 6.64 | 5.71% | | 7.4E−01 | 6.41% |
| | Tb | 4.21 | 3.61% | | 4.7E−01 | 4.23% |
| | Dy | 3.82 | 3.28% | | 4.3E−01 | 3.73% |
| | Ho | 5.54 | 4.76% | | 6.2E−01 | 5.56% |
| | Er | 7.03 | 6.04% | | 7.9E−01 | 6.94% |
| | Tm | 8.43 | 7.24% | | 9.4E−01 | 8.29% |
| | Yb | 9.57 | 8.23% | | 1.1E+00 | 9.50% |
| | Lu | 10.35 | 8.89% | | 1.2E+00 | 10.28% |
| | Th | 0.01 | 0.01% | | 9.6E−04 | 0.01% |
| | Total | 116.35 | | | | |
| Basket 30 | Sc | 0.00 | 0.00% | 198 | 3.8E−05 | 0.00% |
| | Y | 8.69 | 7.35% | | 1.7E+00 | 15.45% |
| | La | 7.58 | 6.41% | | 1.5E+00 | 13.31% |
| | Ce | 8.25 | 6.98% | | 1.6E+00 | 14.78% |
| | Pr | 8.53 | 7.22% | | 1.7E+00 | 15.06% |
| | Nd | 8.46 | 7.16% | | 1.7E+00 | 14.61% |
| | Sm | 7.89 | 6.68% | | 1.6E+00 | 13.58% |
| | Eu | 7.19 | 6.09% | | 1.4E+00 | 12.67% |
| | Gd | 8.10 | 6.85% | | 1.6E+00 | 13.83% |
| | Tb | 6.38 | 5.40% | | 1.3E+00 | 11.35% |
| | Dy | 5.90 | 4.99% | | 1.2E+00 | 10.20% |
| | Ho | 7.15 | 6.05% | | 1.4E+00 | 12.70% |
| | Er | 8.06 | 6.82% | | 1.6E+00 | 14.08% |
| | Tm | 8.43 | 7.13% | | 1.7E+00 | 14.65% |
| | Yb | 8.84 | 7.48% | | 1.7E+00 | 15.52% |
| | Lu | 8.72 | 7.37% | | 1.7E+00 | 15.31% |
| | Th | 0.01 | 0.01% | | 2.5E−03 | 0.02% |
| | Total | 118.19 | | | | |
| Basket 31 | Sc | 0.00 | 0.00% | 10 | 0.0E+00 | 0.00% |
| | Y | 51.98 | 3.95% | | 5.3E−01 | 4.80% |
| | La | 7.72 | 0.59% | | 4.5E−02 | 0.40% |
| | Ce | 19.95 | 1.51% | | 1.6E−01 | 1.49% |
| | Pr | 44.87 | 3.41% | | 4.5E−01 | 3.98% |
| | Nd | 72.12 | 5.47% | | 7.9E−01 | 6.89% |
| | Sm | 117.73 | 8.94% | | 1.7E+00 | 14.72% |
| | Eu | 113.52 | 8.62% | | 1.7E+00 | 15.25% |
| | Gd | 116.99 | 8.88% | | 1.7E+00 | 14.41% |
| | Tb | 109.00 | 8.27% | | 1.6E+00 | 14.67% |
| | Dy | 108.72 | 8.25% | | 1.6E+00 | 14.17% |
| | Ho | 116.43 | 8.84% | | 1.7E+00 | 14.96% |
| | Er | 117.88 | 8.95% | | 1.6E+00 | 14.44% |
| | Tm | 116.54 | 8.85% | | 1.6E+00 | 13.74% |
| | Yb | 110.02 | 8.35% | | 1.4E+00 | 12.50% |
| | Lu | 93.92 | 7.13% | | 1.1E+00 | 9.93% |
| | Th | 0.00 | 0.00% | | 0.0E+00 | 0.00% |
| | Total | 1317.39 | | | | |
| Basket 32 | Sc | 0.00 | 0.00% | 24 | 0.0E+00 | 0.00% |
| | Y | 0.93 | 0.07% | | 2.3E−02 | 0.20% |
| | La | 0.29 | 0.02% | | 7.2E−03 | 0.06% |
| | Ce | 0.45 | 0.03% | | 1.1E−02 | 0.10% |
| | Pr | 0.80 | 0.06% | | 1.9E−02 | 0.17% |
| | Nd | 1.70 | 0.13% | | 4.1E−02 | 0.36% |
| | Sm | 12.10 | 0.92% | | 2.9E−01 | 2.57% |
| | Eu | 14.49 | 1.10% | | 3.5E−01 | 3.14% |
| | Gd | 12.28 | 0.93% | | 3.0E−01 | 2.58% |
| | Tb | 14.69 | 1.11% | | 3.6E−01 | 3.22% |
| | Dy | 14.09 | 1.07% | | 3.4E−01 | 3.00% |
| | Ho | 13.18 | 1.00% | | 3.2E−01 | 2.88% |
| | Er | 11.15 | 0.85% | | 2.7E−01 | 2.40% |
| | Tm | 8.82 | 0.67% | | 2.1E−01 | 1.89% |
| | Yb | 6.64 | 0.50% | | 1.6E−01 | 1.44% |
| | Lu | 3.86 | 0.29% | | 9.4E−02 | 0.84% |
| | Th | 0.00 | 0.00% | | 0.0E+00 | 0.00% |
| | Total | 115.48 | | | | |
| Basket 33 | Sc | 0.00 | 0.00% | 14 | 0.0E+00 | 0.00% |
| | Y | 2.34 | 0.38% | | 3.3E−02 | 0.29% |
| | La | 0.31 | 0.05% | | 4.3E−03 | 0.04% |
| | Ce | 0.66 | 0.11% | | 9.2E−03 | 0.08% |
| | Pr | 1.60 | 0.26% | | 2.2E−02 | 0.20% |
| | Nd | 3.99 | 0.65% | | 5.6E−02 | 0.49% |
| | Sm | 57.40 | 9.34% | | 8.0E−01 | 6.96% |
| | Eu | 84.92 | 13.82% | | 1.2E+00 | 10.53% |
| | Gd | 61.93 | 10.08% | | 8.6E−01 | 7.45% |
| | Tb | 93.44 | 15.21% | | 1.3E+00 | 11.70% |
| | Dy | 95.12 | 15.48% | | 1.3E+00 | 11.58% |
| | Ho | 76.71 | 12.49% | | 1.1E+00 | 9.59% |
| | Er | 57.95 | 9.43% | | 8.1E−01 | 7.13% |
| | Tm | 39.77 | 6.47% | | 5.5E−01 | 4.87% |
| | Yb | 25.73 | 4.19% | | 3.6E−01 | 3.18% |
| | Lu | 12.51 | 2.04% | | 1.7E−01 | 1.55% |
| | Th | 0.00 | 0.00% | | 0.0E+00 | 0.00% |
| | Total | 614.38 | | | | |
| Basket 34 | Sc | 0.00 | 0.00% | 17 | 0.0E+00 | 0.00% |
| | Y | 0.50 | 0.34% | | 8.3E−03 | 0.07% |
| | La | 0.17 | 0.11% | | 2.8E−03 | 0.02% |
| | Ce | 0.25 | 0.17% | | 4.1E−03 | 0.04% |
| | Pr | 0.43 | 0.29% | | 7.2E−03 | 0.06% |
| | Nd | 0.69 | 0.46% | | 1.2E−02 | 0.10% |
| | Sm | 10.88 | 7.27% | | 1.8E−01 | 1.57% |
| | Eu | 22.02 | 14.72% | | 3.7E−01 | 3.26% |
| | Gd | 12.64 | 8.45% | | 2.1E−01 | 1.81% |
| | Tb | 29.15 | 19.48% | | 4.8E−01 | 4.35% |
| | Dy | 29.55 | 19.75% | | 4.9E−01 | 4.29% |
| | Ho | 19.65 | 13.14% | | 3.3E−01 | 2.93% |
| | Er | 11.91 | 7.96% | | 2.0E−01 | 1.75% |
| | Tm | 6.32 | 4.22% | | 1.0E−01 | 0.92% |
| | Yb | 3.75 | 2.51% | | 6.2E−02 | 0.55% |
| | Lu | 1.69 | 1.13% | | 2.8E−02 | 0.25% |
| | Th | 0.00 | 0.00% | | 0.0E+00 | 0.00% |
| | Total | 149.60 | | | | |
| Basket 35 | Sc | 0.11 | 0.15% | 14 | 1.5E−03 | 0.01% |
| | Y | 0.40 | 0.53% | | 5.6E−03 | 0.05% |
| | La | 0.13 | 0.17% | | 1.8E−03 | 0.02% |
| | Ce | 0.20 | 0.27% | | 2.8E−03 | 0.03% |
| | Pr | 0.35 | 0.46% | | 4.9E−03 | 0.04% |
| | Nd | 0.56 | 0.75% | | 7.9E−03 | 0.07% |
| | Sm | 4.91 | 6.56% | | 6.9E−02 | 0.60% |
| | Eu | 11.08 | 14.80% | | 1.6E−01 | 1.39% |
| | Gd | 5.65 | 7.55% | | 8.0E−02 | 0.69% |
| | Tb | 14.67 | 19.60% | | 2.1E−01 | 1.86% |
| | Dy | 15.52 | 20.73% | | 2.2E−01 | 1.91% |
| | Ho | 9.26 | 12.37% | | 1.3E−01 | 1.17% |
| | Er | 5.49 | 7.33% | | 7.7E−02 | 0.68% |
| | Tm | 3.10 | 4.14% | | 4.4E−02 | 0.38% |
| | Yb | 2.12 | 2.84% | | 3.0E−02 | 0.27% |
| | Lu | 1.22 | 1.63% | | 1.7E−02 | 0.15% |
| | Th | 0.08 | 0.11% | | 1.2E−03 | 0.01% |
| | Total | 74.84 | | | | |

The percentage of enrichment was used to quantify enrichment in one or several elements, but the mass percentage of the total was used to indicate the yield or the fraction of the total mass of metal in the system as fractioned into the basket. For example, the Lain Basket 24 has a percentage of enrichment equal to 95.9% and the basket has a volume of 23.5 mL, however, La in this basket accounts for only 0.6% of the total La introduced to the system. Therefore, understanding these Baskets should be done by taking into consideration three important parameters: enrichment. Basket volume, and the mass percentage of total (yield).

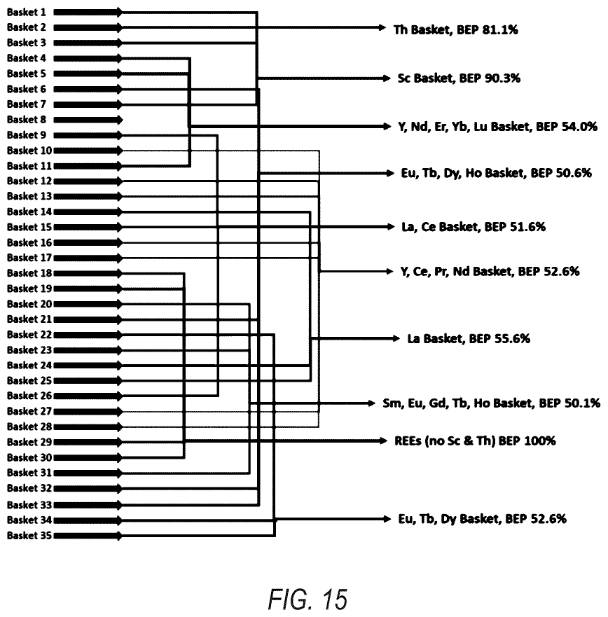

FIG. 15 shows a process for mixing baskets from different columns to produce enriched baskets. The mixing of baskets from Table 3, e.g., mixing of baskets from different columns, resulted in new enriched baskets shown in FIG. 15. The naming of the new Baskets was based on the major elements and their associated basket enrichment percentage (BEP). The Th enriched basket has 81.1% Th, 11% Sc, and 8% other REEs. The next step for this basket to reach a complete separation would be to inject the collected solution (102 mL) through a new column, where Sc and Th can completely sorb to the media Sc, Th, and the other REEs can then be separated using a two-pH release cycle such as shown in FIGS. 9A and 9B. The fractions with Sc can then be combined into the Sc Basket. The Sc Basket (BEP 90.3%) contains 78% of the total Sc in the system and the rest of Sc is in the Th enriched Basket only. The rest of the Baskets are Sc and Th free.

Original baskets of La had an enrichment of 95.9, 64.46, and 61.3% by combining Baskets to preserve mass. The combined La enriched Basket has a BEP of 55.6% where La accounts for more than 20% of total La in the system (1,617 mL, 7 ppm). Ce is also high in this Basket with 27% enrichment and 10% of the total Ce in the system. The third most enriched element in this Basket is Pr with 9.6%, this Basket is a promising start for a new column to obtain high purity La and Ce Baskets. The next basket is a La and Ce enriched basket that has a BEP of 51.6%, which means that the rest of the 15 elements account for 40% of the total concentration, Y and Pr accounts for 27% and this Basket is mostly depleted (less than 1%) of Sc, Sm, Eu, Gd, Tb, Dy, Ho, Er, Tm, and Th. This Basket is a result of mixing seven baskets, one of these Baskets is Basket 14 where La accounts for 64.5% of the total concentrations.

The Eu, Tb, and Dy enriched Basket (BEP 52.6%) also has Tb and Dy accounting for around 39% and Ho accounting for 12%. This can be interpreted that while there are a few enriched LREEs, this Basket is enriched in HREEs (66%). The line representing the Y, Ce, Pr, and Nd Basket has a BEP of 52.6%, and Lu and La are also enriched in this Basket by 10.2 and 9.7%, respectively. The Eu, Tb, Dy, and Ho Basket (BEP 53.6%) is mostly depleted in Sc, Y, La, Ce, Pr and Th. An enriched separation would be expected if this Basket was injected through a new column, where Nd, Sm and Eu will be released during the loading cycle and then HREEs will be enriched during the release cycle.

The BEP goes down with the Y, Nd, Er, Yb, and Lu Basket (BEP 54.0%) on one hand and the Sm, Eu, Gd, Tb, and Ho Basket (BEP 50.1%) on the other, but both baskets have unique characteristics. The first basket is not enriched in REEs mass percentage of total because none of the REEs exceeded 1.6%. The Sm. Eu, Gd, Tb, and Ho Basket contained more than 24% of the total mass of each of the enriched elements. Finally, the REEs (no Sc & Th) Basket is enriched by only eliminating Sc and Th from the solution and the rest of the elements all have almost the same concentration.

### Mass Balance

Mass balances were calculated to track the masses of individual REEs+Th through the separation process, starting from the influent solution of Col. 1 (Sol. 1). TABLE 4 shows the recovered masses through the six columns used for separations. Th is the lowest (81%) and this is likely because the release of Column 1 at pH 0.03 (FIG. 6.8 B) was stopped before releasing all Th and Sc in the column and the sorbent material was discarded before further analysis. It is important to note that LREEs were recovered earlier in the process, and this also reduced the error associated with them. Reasons that can be attributed to not closing the mass balances: (1) the loss (spill) of 4.9 mL solution from the release of Column 1 that was enriched in the HREEs; (2) stopping the release process before the complete release of all REEs from the column, which has a larger effect on the HREEs than LREEs; (3) instruments errors (e.g., balance and ICP-MS variability); (4) Cumulative error due to the large number of processed samples (>810 samples) which includes dilution, pipetting, and weighing.

TABLE 4

| Element | Solution 1 mass (mg) | Recovered |
|---|---|---|
| Sc | 11.4 | 91% |
| Y | 11.1 | 99% |
| La | 11.3 | 100% |
| Ce | 11.0 | 102% |
| Pr | 11.2 | 99% |
| Nd | 11.4 | 94% |
| Sm | 11.5 | 88% |
| Eu | 11.2 | 90% |
| Gd | 11.6 | 88% |
| Tb | 11.1 | 89% |
| Dy | 11.4 | 85% |
| Ho | 11.1 | 90% |
| Er | 11.3 | 89% |
| Tm | 11.4 | 92% |
| Yb | 11.3 | 92% |
| Lu | 11.3 | 95% |
| Th | 11.1 | 81% |

It should be appreciated that the specific measurements, concentrations, and the like described above were for the experiments and are not intended to be limiting in any way.

From the above, a unique approach of using a series of media filled columns was devised to separate individual REEs from a solution containing a mix of REEs and Th into high purity groups referred to as enriched baskets. This approach is organic solvent-free with large room for optimization, creativity, and flexibility. A 1.6-liter solution was prepared containing all 16 REEs (no Pm)+Th with equal concentrations (≈7 ppm each). The solution was passed through a relatively large column (Column 1) and the resulting solutions from loading and release cycles were collected and passed through subsequent columns. Baskets (mixing of fractions) were generated from all columns and were analyzed, then Baskets from different columns were mixed with each other and a basket enrichment percentage (BEP) was assigned to each basket. BEP was developed to combine information about a given Basket and it is the additive enrichment percentages of individual elements that accounts for at least 50% of the total concentration. Using this process, a high purity Sc (90%) and Th baskets (81%) were produced. Moreover, La was also enriched in multiple Baskets with percentages of 95.9, 64.46, 61.3, and 55.6%. Other baskets contained multiple elements like the La and Ce Basket with La and Ce accounted for more than 30% enrichment, which is a more than 5 times their initial concentration (5.9%). Other elements were also enriched, for example Dy and Tb were both enriched to around 19% for each. And while all the 9 Baskets resulted from this work were enriched in one or few elements, another set of columns would be required for further separation and purifications following the same proposed procedure.

The present disclosure demonstrates that a series of columns can be used for separating REEs+Th from a solution without any need for organic solvent (other than a nominal amount used in the media synthesis). The simplicity of this system offers flexibility and can be optimized for better performance in future work.

Pursuant to a first aspect, an exemplary process for sequential column separation of REEs may include passing a solution containing a mix of REEs through a first column containing a modified ligand-associated media; collecting effluent fractions of the solution from the first column; combining a first subset of the effluent fractions together to form a first combined fraction solution; combining a second subset of the effluent fractions together to form a second combined fraction solution, wherein the second subset of the effluent fractions differs in included REEs from the first subset of the effluent fractions; passing the first combined fraction solution through a second column containing the modified ligand-associated media and collecting effluent fractions of the first combined fraction solution; and passing the second combined fraction solution through a third column containing the modified ligand-associated media and collecting effluent fractions of the second combined fraction solution.

The process may further include analyzing the effluent fractions of the first combined fraction solution and of the second combined fraction solution to determine an REE concentration of the effluent fractions; and separating the effluent fractions of the first combined fraction solution into first baskets and the effluent fractions of the second combined fraction solution into second baskets, wherein each basket comprises effluent fractions of a similar REE concentration.

The process may further include combining at least one basket from the first baskets with at least one basket from the second baskets to form an enriched basket.

The enriched basket includes one or more REEs where an additive percentage of the one or more REEs amounts to at least 50% of a total concentration.

The first subset of the effluent fractions are combined based on a concentration and content of included REEs of each fraction.

A pH of the first combined fraction solution may be adjusted (e.g., increased) before passing through the second column. Additionally, or alternatively, the first column is larger than the second column and the third column.

The process may include passing at least one acidic release solution through the first column and collecting extracted fraction solutions; combining a first subset of the extracted fraction solutions together and at least one second subset of the extracted fraction solutions together, wherein the first subset of the extracted fraction solutions differs in concentration of REEs from the second subset of the extracted fraction solutions; and passing the first subset of the extracted fraction solutions through a fourth column containing the modified ligand-associated media.

The at least one acidic release solution has a pH of between 0.0 and 2.0.

Additionally, or alternatively, the process may include passing a plurality of acidic release solutions through at least one of the second column and the third column and collecting fractions of the plurality of acidic release solutions, wherein a first of the plurality of acidic release solutions has a pH of about 1.6, a second of the plurality of acidic release solutions has a pH of about 1.0, and a third of the plurality of acidic release solutions has a pH of about 0.0.

The plurality of acidic release solutions are passed sequentially in order of the first of the plurality of acidic release solutions, then the second of the plurality of acidic release solutions, then the third of the plurality of acidic release solutions.

The ligand may be commercially available ligands, including, but not limited to, dipentyl pentylphosphonate or P,P′-di(2-ethylhexyl) methanediphosphonic acid (DIPEX).

Alternatively, the ligand may also be diethylenetriaminepentaacetic acid (DTPA) functionalized with hydrophobic groups to form a modified DTPA, which has been found to demonstrate the ability to bind rare-earth elements effectively and to release them in a reasonable pH range (pH 1-5). The hydrophobic groups include alkyl groups such as alkylamines. In particular, the DTPA may be modified by two hydrophobic ethylhexyl groups to comprise bis(ethylhexyl)amido DTPA.

The modified DTPA may have the following formula:

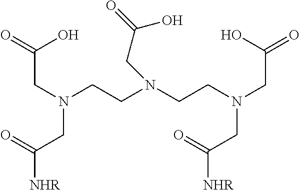

wherein R is C₄H₉, C₆H₁₃, C₁₂H₂₅, C₁₄H₂₉, or C₁₆H₃₃.

The solution containing the mix of REEs may be prepared from a source such as a coal fly ash leachate or e-waste.

Pursuant to a second aspect, an exemplary process for solid-liquid extraction of REEs may include passing a mixed REE solution through a plurality of columns containing a modified ligand-associated media to generate solution fractions; analyzing the solution fractions for REE content and concentration; combining fractions from the same column into baskets based on the REE content and concentration; and mixing baskets from different columns to produce enriched baskets.

Pursuant to an implementation, the passing of the mixed REE solution through the plurality of columns includes passing the mixed REE solution through a first column containing the modified ligand-associated media and collecting effluent fractions of the mixed REE solution from the first column; combining a first subset of the effluent fractions together to form a first combined fraction solution; and passing the first combined fraction solution through a second column containing the modified ligand-associated media and collecting effluent fractions of the first combined fraction solution.

Pursuant to a further implementation, the passing of the mixed REE solution through the plurality of columns includes passing at least one acidic release solution through the first column and collecting fractions of the at least one acidic release solution, wherein at least one of the fractions of the at least one acidic release solution are combined and passed through a subsequent column containing the modified ligand-associated media for REE extraction. The at least one acidic release solution has a pH of 0.0 to 2.0.

At least some effluent fractions from the second column may be analyzed and combined with a second subset of the effluent fractions from the first column to form an enriched basket. The enriched baskets contain one or more REEs with an additive percentage of at least 50% of a total concentration.

The mixed REE solution is prepared from a coal fly ash leachate or an electronic waste leachate. Additionally, or alternatively, the modified ligand-associated media includes diethylenetriaminepentaacetic acid (DTPA) functionalized with hydrophobic groups with the DTPA being chemically associated with an organosilica platform.

The disclosure further relates to a system of sequential column extraction/separation of REEs according to the first aspect and/or the second aspect of the disclosure, as described and shown herein.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Further, the use of “at least one of” is intended to be inclusive, analogous to the term and/or. Furthermore, any numerical examples in the following discussion are intended to be non-limiting, and thus additional numerical values, ranges, and percentages are within the scope of the disclosed embodiments.

While the disclosed materials and processes have been described in detail in connection with only a limited number of embodiments, it should be readily understood that the embodiments are not limited to such disclosed embodiments. Rather, that disclosed can be modified to incorporate any number of variations, alterations, substitutions, or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed is:

1. A process for sequential column separation of rare earth metals (REEs) comprising:
passing a solution containing a mix of REEs through a first column containing a modified ligand-associated media;
collecting effluent fractions of the solution from the first column;
combining a first subset of the effluent fractions together to form a first combined fraction solution;
combining a second subset of the effluent fractions together to form a second combined fraction solution, wherein the second subset of the effluent fractions differs in included REEs from the first subset of the effluent fractions;
passing the first combined fraction solution through a second column containing the modified ligand-associated media and collecting effluent fractions of the first combined fraction solution; and
passing the second combined fraction solution through a third column containing the modified ligand-associated media and collecting effluent fractions of the second combined fraction solution.

2. The process of claim 1, further comprising analyzing the effluent fractions of the first combined fraction solution and of the second combined fraction solution to determine an REE concentration of the effluent fractions; and
separating the effluent fractions of the first combined fraction solution into first baskets and the effluent fractions of the second combined fraction solution into second baskets, wherein each basket comprises effluent fractions of a similar REE concentration.

3. The process of claim 2, further comprising combining at least one basket from the first baskets with at least one basket from the second baskets to form an enriched basket.

4. The process of claim 3, wherein the enriched basket includes one or more REEs where an additive percentage of the one or more REEs amounts to at least 50% of a total concentration.

5. The process of claim 1, wherein the first subset of the effluent fractions are combined based on a concentration and content of included REEs of each fraction.

6. The process of claim 1, further comprising adjusting a pH of the first combined fraction solution before passing through the second column.

7. The process of claim 1, further comprising passing at least one acidic release solution through the first column and collecting extracted fraction solutions;
combining a first subset of the extracted fraction solutions together and at least one second subset of the extracted fraction solutions together, wherein the first subset of the extracted fraction solutions differs in concentration of REEs from the second subset of the extracted fraction solutions; and
passing the first subset of the extracted fraction solutions through a fourth column containing the modified ligand-associated media.

8. The process of claim 6, wherein the at least one acidic release solution has a pH of between 0.0 and 2.0.

9. The process of claim 1, further comprising passing a plurality of acidic release solutions through at least one of the second column and the third column and collecting fractions of the plurality of acidic release solutions, wherein a first of the plurality of acidic release solutions has a pH of about 1.6, a second of the plurality of acidic release solutions has a pH of about 1.0, and a third of the plurality of acidic release solutions has a pH of about 0.0.

10. The process of claim 9, wherein the plurality of acidic release solutions are passed sequentially in order of the first of the plurality of acidic release solutions, then the second of the plurality of acidic release solutions, then the third of the plurality of acidic release solutions.

11. The process of claim 1, wherein the modified ligand-associated media is a modified DTPA-associated organosilica media.

12. The process of claim 1, wherein the solution containing the mix of REEs is a fly ash leachate solution.

13. The process of claim 1, wherein the first column is larger than the second column and the third column.

14. A process for solid-liquid extraction of rare earth metals (REEs), comprising:
passing a mixed REE solution through a plurality of columns containing a modified ligand-associated media to generate solution fractions;
analyzing the solution fractions for REE content and concentration;
combining fractions from the same column into baskets based on the REE content and concentration; and
mixing baskets from different columns to produce enriched baskets.

15. The process of claim 14, wherein passing the mixed REE solution through the plurality of columns includes:
passing the mixed REE solution through a first column containing the modified ligand-associated media and collecting effluent fractions of the mixed REE solution from the first column;
combining a first subset of the effluent fractions together to form a first combined fraction solution; and
passing the first combined fraction solution through a second column containing the modified ligand-associated media and collecting effluent fractions of the first combined fraction solution.

16. The process of claim 15, wherein passing the mixed REE solution through the plurality of columns further includes passing at least one acidic release solution through the first column and collecting fractions of the at least one acidic release solution, wherein at least one of the fractions of the at least one acidic release solution are combined and passed through a subsequent column containing the modified ligand-associated media for REE extraction.

17. The process of claim 16, wherein the at least one acidic release solution has a pH of 0.0 to 2.0.

18. The process of claim 15, wherein at least some effluent fractions from the second column are analyzed and combined with a second subset of the effluent fractions from the first column to form an enriched basket.

19. The process of claim 14, wherein the enriched baskets contain one or more REEs with an additive percentage of at least 50% of a total concentration.

20. The process of claim 14, wherein the mixed REE solution is prepared from a coal fly ash leachate or an electronic waste leachate, and wherein the modified ligand-associated media includes diethylenetriaminepentaacetic acid (DTPA) functionalized with hydrophobic groups with the DTPA being chemically associated with an organosilica platform.
